(19) United States
(12) Patent Application Publication
(10) Pub. No.: US 2025/0098630 A1
(43) Pub. Date: Mar. 27, 2025

(54) Low Tracking Clumping Litter

(71) Applicants: John M. Lipscomb, Cedarburg, WI (US); Omar I. Rodriguez, Cedarburg, WI (US)

(72) Inventors: John M. Lipscomb, Cedarburg, WI (US); Omar I. Rodriguez, Cedarburg, WI (US)

(21) Appl. No.: 18/741,466

(22) Filed: Jun. 12, 2024

Related U.S. Application Data
(63) Continuation-in-part of application No. 18/372,677, filed on Sep. 25, 2023.

(51) Int. Cl. A01K 1/015

(52) U.S. Cl. CPC A01K 1/0152

(57) ABSTRACT

A low tracking clumping litter is provided that has larger non-clumping litter particles with particle sizes sufficiently large enough relative to smaller clumping litter particles thereby disposing substantially all the smaller particles of litter in a litter box below the surface of the litter packing them into in voids between adjacent non-clumping particles. This reduces tracking because the surface is made up of the larger particles, which are not readily picked up by a cat, minimizing the number of smaller more readily tracked particles on top because they are packed in the voids. This causes urine to rapidly wet and swell the clumping particles trapping the urine forming the clump on top. The litter has a tracking effectiveness of less than 100 particles/in² and clumping particles preferably composed of extrusion modified starch-based water-soluble binder produce shed-resistant clumps having clump retention rates preferably greater than 97%.

### CROSS REFERENCE

This application claims priority in and the benefit of U.S. Provisional Patent Application No. 63/465,916 filed May 12, 2023, the entire disclosure of which is hereby expressly incorporated herein by reference. This application also is a continuation-in-part of PCT Application No. PCT/US2024/029178, filed May 13, 2024, which claims priority in and the benefit of U.S. Provisional Patent Application No. 63/465,916 filed May 12, 2023, the entire disclosures of each of which are hereby expressly incorporated herein by reference. Finally, this application also is a continuation-in-part of U.S. patent application Ser. No. 18/372,677, filed Sep. 25, 2023, which claims priority in and the benefit of U.S. Provisional Patent Application No. 63/409,755 filed Sep. 24, 2022, the entire disclosures of which are each hereby expressly incorporated herein by reference.

### FIELD

The present invention is directed to granular absorbents, preferably litter, for use by animals, and more particularly to clumping litter that is a blend of at least one type of clumping particle and at least one type of non-clumping particle having particles sized sufficiently larger than particles of the at least one type of clumping particle that reduces tracking of particles by an animal using the litter in a litterbox.

### BACKGROUND

When a cat uses a litterbox containing litter composed of litter particles that include absorbent granules, it is common for a cat to undesirably track some of the litter particles out of the box when they leave the box. The process of litter being tracked out of the box by a cat typically occurs in a number of ways:

Entry and digging: As the cat enters the litter box, it may pick up litter particles that cling to its fur, especially if it has long hair. Because cats instinctively dig to bury their waste, this action can cause litter particles to stick to their paws. During digging, cats might stir up the litter, causing some of it to scatter on the floor near the edge of the box or stick to their bodies.

Use of the litter box: After the cat has finished its business and buried its waste, it will often cover up the feces or urine by scraping more litter over it. This action is another opportunity for particles of litter to adhere to the cat's paws. Clumping litter, which is designed to absorb moisture and form clumps, tends to stick more readily to the paws than non-clumping varieties.

Exiting the litter box: As the cat exits the litter box, it may carry out litter particles that are stuck between its toes or which cling to its fur. The texture and length of the cat's fur, as well as the moisture on its paws, can influence how much litter is carried out. Longer, denser fur can trap more litter.

Post litter box cleaning: Cats often engage in post-elimination grooming, licking their paws and fur. During this grooming, it is common for the cat to dislodge litter particles from their paws, which then fall onto the floor outside the litter box.

Movement around the house: As the cat moves around the house, any remaining litter particles on its paws or fur may be dislodged due to the cat's movements. This leads to a trail of litter particles being spread around the area near the litter box, and potentially further, depending on the cat's activities post-litter box use.

To mitigate this, many cat owners use a mat placed around the litterbox to catch some of the litter granules tracked by the cat that falls off the cat as it exits the box. Regular cleaning and maintenance of the litter box and surrounding area also help minimize the spread of litter outside the box. Despite the use of a mat to catch tracked litter and performing regular litter box cleaning and maintenance, it nonetheless is still very common for litter to be tracked by a cat beyond the mat that later falls off from the cat necessitating frequent cleanup of the floor by the cat owner.

In response, manufacturers of litter have tried to develop low tracking litter, albeit with limited success. One type of low track or low tracking litter that manufacturers have introduced is made of crystals of silica gel litter because the silica gel crystals are less likely to adhere to a cat's fur and paws. Other types of low track litter are non-clumping litter that use granules or pellets that are larger and heavier than used in standard cat litter because they are less likely to get stuck in a cat's paws or adhere to the cat's fur.

U.S. Patent Application Publication No. US20050160997 discloses a non-clumping cat and small animal litter composed of yellow pine wood fiber and a nonionic surfactant formed into pellets using a pellet mill which have a relatively large pellet diameters of between 4762 and 6350 microns (0.1875 inches to 0.250 inches). While the '997 publication discloses pellets having these large pellet diameters “can be retained whole to limit tracking by the animal from the litter pan”, it teaches that use of whole pellets may not be comfortable for the animal by further disclosing that the pellets “may be crumbled and screened for a [softer] texture and thus greater animal comfort.”

Attempts to make a clumping litter that tracks less have proven more challenging because granules of a clumping material, such as granules of sodium bentonite or another type of clumping material, tend to be sticky in nature which causes them to more readily adhere not only to a cat's paws but to their fur as well.

One example of a clumping animal litter intended to reduce tracking is disclosed in U.S. Pat. No. 11,918,969 is made of composite litter particles composed of sodium bentonite and activated carbon having a particle size distribution of 16/50 mesh ranging from 300 microns to 1180 microns in size. The litter purports to reduce tracking by eliminating nearly all the fine particles, commonly referred to as “fines”, in the litter which would pass through a size 100 mesh (e.g., 0.150 mm or 150 μm sieve opening) by limiting the amount of fines in the litter to no more than about 10%, about 5%, about 4%, about 3%, about 2.5%, about 2%, about 1.5%, or about 1% of the litter. However, despite significantly reducing and even nearly eliminating fines from the litter, tracking unfortunately will still nonetheless occur with this litter due to the relatively small size of the composite litter particles that actually make up the litter.

U.S. Pat. No. 8,720,375 discloses another clumping litter formulated to reduce tracking that is composed of particles of a clay-based liquid-absorbing material, such as sodium bentonite, and particles of at least one filler consisting of a non-absorbent, non-soluble substrate coated with at least one clumping agent, which can also be sodium bentonite. The particles of clay-based liquid-absorbing material have a relatively small particle size of between 500 microns and 2000 microns (between 0.50 mm and 2.00 mm), preferably between 400 microns and 1600 microns (between 0.4 mm and 1.6 mm), and more preferably between 400 microns and 1200 microns (between 0.4 mm and 1.2 mm). The particles of clay-based liquid-absorbing material make up between 40% and 99%, preferably between 50% and 95%, and more preferably between 40% and 85%, by weight of the litter. The clay-based liquid-absorbing material is selected from clumping and non-clumping clay materials or a mixture of clumping and non-clumping clay materials. The filler particles also have a small particle size of between 250 microns and 850 microns (between 0.25 mm and 0.85 mm) and make up between 10% and 60%, preferably 30% and 60%, and more preferably 45% and 60% by weight of the litter. The clumping agent can be a clumping clay, e.g., sodium bentonite, a polysaccharide, a water-soluble gum, a dry particulate cellulose ether, a water absorbent polymer, or a mixture thereof. The clumping agent is present in an amount between 0.1% and 20%, preferably 0.25% and 10%, and more preferably 0.45% and 7.0% by weight of the litter. However, tracking will also still occur with this litter due to the relatively small size of the litter particles that make up the litter.

In addition, because most clumping litters, including the above purported reduced tracking clumping litters, predominantly use only sodium bentonite to clump, the sodium bentonite swells upon absorbing urine during clumping and forms a clump that shrinks when it dries. Unfortunately, sodium bentonite lacks the plasticity to prevent tensile and compressive stresses that build up in the clump during drying and shrinking that can cause cracks to form in the dried clump. The formation of such cracks in the dried clump can cause the clump to crumble or even collapse as it is being scooped out of the litter box in turn causing the clump to shed fragments of spent litter that fall from the clump back into the litter. Such shedding is undesirable because it can cause contamination of the litter requiring more frequent litter box cleaning and lead to more rapid depletion of the litter. It can also cause the litter to become undesirably odorous because the shed portions of the clump that are returned to the litter box can harbor odor-causing bacteria as well as other bacteria which can be deleterious to a cat's health. This can even lead to the cat eliminating outside the litter box.

What is needed is an improved clumping litter formulation which minimizes tracking while still clumping well. What is also needed is a low tracking clumping litter formulation that produces clumps that shed less or not at all when being removed from the litter box.

### SUMMARY

The present invention is directed to a low tracking clumping litter that is formulated of a litter blend of smaller clumping litter particles of a clumping material and larger non-clumping litter particles of a non-clumping material whose respective varying clumping and non-clumping particle sizes define corresponding clumping and non-clumping particle size ranges selected to configure the litter so that when it is poured into a litter box (a) the larger non-clumping particles are distributed along and substantially completely form a top surface of the litter to minimize tracking of litter particles by a cat using the litter, and (b) the smaller clumping particles flow into voids below the surface between non-clumping particles to trap urine from a cat using the litter near the top surface so that scoopable clumps form on the litter's surface. The varying sized non-clumping particles of the litter blend are selected, such as by screening or sieving, to define a non-clumping particle size range having the smallest sized non-clumping particles being large enough in size to minimize the number of non-clumping particles picked up by the paws of the cat walking on the top surface of the litter. If desired, such a litter can be a multi-component low tracking clumping litter blend composed of at least a plurality of different clumping particles and non-clumping particles of one type or one kind, e.g., made of different kinds of clumping or non-clumping material, at least a plurality of different non-clumping particles and clumping particles of one type or one kind, or at least a plurality of different clumping particles, e.g., made of different kinds of clumping material, and at least a plurality of different non-clumping particles, e.g., made of different kinds of non-clumping material. Such a low tracking clumping litter of the present invention has a desirably low litter particle tracking effectiveness of no greater than 150 litter particles per square inch, preferably no greater than 100 litter particles per square inch, and forms clumps on top which are desirably low-shedding having a clump retention rate of at least 95%, preferably at least 97%.

The varying sized clumping particles of the litter blend are selected, such as by screening or sieving, to define a clumping particle size range having the largest sized clumping particles being no more than about 25% larger in size than the smallest sized non-clumping particles and which thereby are small enough to minimize the number of smaller clumping particles that end up being disposed on or along the top surface of the litter further minimizing track by minimizing the number of smaller stickier clumping particles available on the litter's surface to be picked up by a cat's paw. The non-clumping litter particles are selected, such as by screening or sieving, to have a minimum particle size of at least 1400 microns to ensure that the non-clumping particles in the litter are large enough to prevent the non-clumping particles that form the top surface of litter poured into a litter box from becoming embedded in the paws of a cat walking on the top surface of the litter. The clumping particles are selected, such as by screening or sieving, to have a maximum particle size of no greater than 2000 microns to ensure that the clumping particles have small enough particle sizes so that they automatically distribute themselves below the top surface of litter poured into the litter box and become packed into voids formed between and below larger adjacent non-clumping particles so that clumps form on top of the litter by trapping urine from a cat using the litter at or near the top of the litter.

Such a litter blend can be and preferably is formulated to produce a low tracking clumping litter of the present invention having clumping particles with a minimum particle size no smaller than 200 microns, preferably no smaller than 250 microns, and more preferably no smaller than about 500 microns, and non-clumping particles no larger in size than about 5500 microns, preferably no larger than 5000 microns, and more preferably no larger than about 4750 microns. In at least one preferred low tracking clumping litter, the non-clumping particles have particle sizes ranging between 1400 microns and 5500 microns and the clumping particles have particle sizes ranging between 200 microns and 2000 microns. In another preferred litter blend, the non-clumping particles have particle sizes ranging between 1500 microns and 5000 microns and the clumping particles have particle sizes ranging between 250 microns and 1900 microns. In a further preferred blend, the non-clumping particles have particle sizes ranging between about 1700 microns and about 4750 microns and the clumping particles have particle sizes ranging between about 500 microns and about 1700 microns.

Such a litter blend produces a low tracking clumping litter of the present invention that is desirably light in weight and economical to make as it has a bulk density of between 20 lbs/ft³ and 50 lbs/ft³ and minimizes the amount of more expensive clumping particles used as it contains between 10% and 45% of the clumping litter particles and no more than 55% and 90% of the more inexpensive non-clumping litter particles. One or more such preferred litter blends are formulated to produce low tracking clumping litter having a bulk density of between 25 lbs/ft³ and 40 lbs/ft³, preferably between about 27 lbs/ft³ and about 37 lbs/ft³, and between 15% and 40%, preferably between about 15% and about 35%, of the more expensive clumping litter particles and no more than 60% and 85%, preferably between about 65% and about 85%, of the less expensive non-clumping litter particles. In one such preferred litter, the litter blend is formulated to have a bulk density of between 25 lbs/ft³ and 40 lbs/ft³, preferably between about 27 lbs/ft³ and about 37 lbs/ft³ and about 30%±5% of the clumping particles and about 70%±5% of the non-clumping particles.

Such litter blends produce a low tracking clumping litter in accordance with the present invention which has exceptionally low tracking characteristics possessing a litter particle tracking effectiveness of no greater than 150 litter particles per square inch where no more than 150 particles of the litter are picked up from the surface of the litter per square inch of litter surface area during carrying out a litter particle tracking effectiveness test whose test procedure is set forth in detail hereinbelow. One or more such litter blends produce litters of the present invention having an even better litter particle tracking effectiveness of no more than 100 particles per square inch, preferably no more than 80 particles per square inch, and more preferably no more than about 60 particles per square inch. Such litter blends also produce a low tracking clumping litter in accordance with the present invention which form clumps on the top surface of the litter due to the smaller clumping particles filling voids between and underneath adjacent larger non-clumping particles preferably producing low-shedding clumps when wetted with urine or water having a clump retention rate of at least 95%, preferably at least 97%.

It also has been surprisingly discovered that the proportion of the weight percent of the clumping particles of such litter blends relative to the weight percent of the non-clumping particles of such litter blends is between 0.10 and 0.82, preferably 0.15 and 0.70, and more preferably about 0.3 and about 0.55 as this results in a low tracking clumping litter of the present invention having a desirably low litter particle tracking effectiveness of no greater than 150 particles per square inch, preferably no greater than 100 particles per square inch, more preferably no greater than 80 particles per square inch, and even more preferably no greater than about 60 particles per square inch. Such litter blends also produce shedding clumps having a clump retention rate of at least 95% and preferably at least 97% which are advantageously low shedding. In at least one preferred litter blend embodiment, at least 75% of the clumping particles in the litter have particle sizes smaller than the non-clumping particles of the litter. In at least one other preferred embodiment, substantially all of the clumping particles have particle sizes no larger than about the smallest sized particles of the non-clumping particles. In at least one such preferred embodiment, all of the clumping particles have particle sizes no larger than the smallest sized particles of the non-clumping particles. In addition, such litter blends that produce a low tracking clumping litter in accordance with the present invention having such desirably low tracking and desirably low-shedding clumping characteristics can and preferably also have a mean particle size ratio of the mean particle size of the non-clumping particles divided by the mean particle size of the clumping particles that ranges between 2.80 and 3.15, preferably between 2.85 and 3.05, and more preferably between about 2.88 and about 2.95.

It also has been unexpectedly discovered that litter blend formulations that have the largest sized clumping particles no larger than the smallest sized non-clumping particles and the ratio of the smallest sized non-clumping particles relative to the largest sized clumping particles falls within a predetermined range of ratios of between about 1 and about 2.5, preferably between 1 and 2, results in the litter being low tracking by having a litter particle tracking effectiveness of no greater than 150 particles per square inch, preferably no greater than 100 particles per square inch, more preferably no greater than 80 particles per square inch, and more preferably no greater than about 60 particles per square inch. Such low tracking clumping litters configured with clumping and non-clumping particle blends having ratios of the smallest sized non-clumping particles relative to the largest sized clumping particles falling between about 1 and about 2.5, preferably between 1 and 2, advantageously results in all of the clumping particles being sized sufficiently small, preferably sufficiently smaller than, and relative to the non-clumping particles to ensure that smaller sized clumping particles will be distributed between and underneath at least a plurality of pairs, i.e., at least three, of the larger sized non-clumping particles that are adjacent to other larger sized non-clumping particles to sufficiently pack them into the voids between these at least plurality of pairs of adjacent non-clumping particles to trap urine near the top of the litter and cause clumps to form on top of the litter.

The present invention also is directed to a low tracking clumping cat litter that is a blend of (a) one or more non-clumping particles with one of the clumping particles having some difference relative to another one of the clumping particles, such as preferably being made of different non-clumping materials, and (b) one or more clumping particles with one of the clumping particles having some difference relative to another one of the clumping particles, such as preferably being made of different clumping materials, where the non-clumping particles of the blend have particle sizes sufficiently larger than the clumping particles configuring the litter to have a relatively low litter particle tracking effectiveness of no higher than 150 particles per square inch, preferably no higher than 100 particles per square inch, more preferably no higher than 80 particles per square inch, and even more preferably no greater than about 60 particles per square inch. The non-clumping particles have larger particles with particle sizes large enough to avoid being picked up by paws of a cat walking on a top surface of the litter and the clumping particles have smaller particles with particle sizes small enough to cause substantially all of the smaller stickier clumping particles to be disposed below the surface away from a cat's paws resulting in the top surface being substantially completely composed of the larger non-clumping particles. The smaller clumping particles are distributed below the litter's surface where they become packed into voids between and below the non-clumping particles that swell when wetted with urine plugging the voids and trapping the urine near the top surface causing a clump of the litter particles to form on top of the litter.

The larger-sized non-clumping particles have particle sizes falling within a non-clumping litter particle size range that is larger than a clumping particle size range within which the clumping particles fall. The non-clumping particle size range is defined by upper and lower non-clumping particle range boundary particle sizes and the clumping particle size range is defined by upper and lower clumping particle range boundary particles sizes.

It has been surprisingly found where the ratio of the lower non-clumping particle range boundary particle size, i.e., the smallest size non-clumping particle, to the lower clumping particle range boundary particle size, i.e., the smallest size clumping particle, is between about 3 and about 6 and the ratio of the upper non-clumping particle range boundary particle size, i.e., the largest size non-clumping particle, to the upper clumping particle range boundary particle size, i.e., the largest size clumping particle, is between about 2 and about 4, the result will be that the litter will have a desirably low litter particle tracking effectiveness of no higher than 150 particles per square inch, preferably no higher than 100 particles per square inch, more preferably no higher than 80 particles per square inch, and even more preferably no greater than about 60 particles per square inch.

It also has been surprisingly found that a litter of the present invention formulated with at least a plurality, preferably at least a plurality of pairs of, i.e., at least three, non-clumping particles having a non-clumping particle size range, and (b) at least a plurality, preferably at least a plurality of pairs of, i.e., at least three, clumping particles having a clumping particle size range, and where the ratio of the particle sizes of the non-clumping particles 46 relative to the sizes of the clumping particles 42 ranges from about 2:1 to about 14:1 configures the litter to have a desirably low litter particle tracking effectiveness of no higher than 150 particles per square inch, preferably no higher than 100 particles per square inch, more preferably no higher than 80 particles per square inch, and even more preferably no greater than about 60 particles per square inch.

In one preferred low tracking litter embodiment, the ratio of the smallest sized particles of the non-clumping particles to the smallest sized particles of the clumping particles ranges between about 6.5 and about 17.5, such as where the smallest size non-clumping particle is no smaller than between about 3250 microns and about 3500 microns, and the smallest size clumping particle is no smaller than between about 200 microns and about 500 microns and the ratio of the largest sized particles of the non-clumping particles to the largest sized particles of the clumping particles ranges between about 2.2 and about 3.5, such as where the largest size non-clumping particles are no larger than between about 4500 microns and about 5000 microns and the largest size clumping particles are no larger than between about 1500 microns and 2000 microns configures the litter to have such a desirably low litter particle tracking effectiveness. In one such preferred low tracking litter embodiment, the ratio of the smallest sized particles of the non-clumping particles to the smallest sized particles of the clumping particles is about 6.7±0.75, such as where the smallest size non-clumping particle is no smaller than about 3350 microns, and the smallest size clumping particle is no smaller than about 500 microns and the ratio of the largest sized particles of the non-clumping particles to the largest sized particles of the clumping particles ranges between about 2.8±0.75, such as where the largest size non-clumping particles are no larger than about 4750 microns and the largest size clumping particles are no larger than about 1700 microns configures the litter to have such a desirably low litter particle tracking effectiveness. In at least one such preferred low tracking litter embodiment, the ratio of the smallest sized particles of the non-clumping particles to the smallest sized particles of the clumping particles of the litter ranges between 6 and 7.5, and the ratio of the largest sized particles of the non-clumping particles to the largest sized particles of the clumping particles ranges between 2 and 3.6.

In another preferred low tracking litter embodiment, the ratio of the smallest sized particles of the non-clumping particles to the smallest sized particles of the clumping particles ranges between about 3.4:1 and about 8.5:1, such as where the smallest size non-clumping particle is no smaller than about 1700 microns, and the smallest size clumping particle is no smaller than between 200 microns and 500 microns. In such a preferred embodiment, the ratio of the largest size particles of the non-clumping particles 46 to the largest sized particles of the clumping particles ranges between 19:6 and 19:8, such as where the largest size non-clumping particle 46 is about 4750 microns and the largest size clumping particle 42 varies between 1500 microns and 2000 microns.

A preferred litter is made of a blend of between 10% and 40%, preferably between about 15% and about 35%, by litter blend weight of the clumping particles and of between 60% and 90%, preferably between about 75% and about 85%, by litter blend weight of the non-clumping particles. Another preferred litter is a blend of between about 15% and about 30% of the clumping particles and between about 70% and about 85% of the non-clumping particles. The blend can be composed of a plurality of different clumping particles, such as clumping particles that differ from each other by being made of different types of clumping material. Likewise, the blend can be composed of a plurality of different non-clumping particles, such as non-clumping particles that differ from each other by being made of different types of non-clumping material.

In at least one preferred embodiment, at least some of the clumping particles are composed at least partially or substantially completely of a starch-containing clumping material, such as a clumping material that is a starch-based extrudate, with the starch-containing clumping particles composed of at least 40%, preferably at least 50%, and more preferably at least 60% starch by clumping particle weight. Such a starch-containing clumping material can be or contain a starch-based clumping agent that facilitates clumping by forming a flowable adhesive clumping agent that flows from clumping particles of such a starch-containing clumping material that are wetted with urine or water during litter use. Where the litter is a blend that includes starch-containing clumping particles, the clumps produced are shedding-resistant as they have a clump retention rate of at least 97%, preferably at least 98%, and more preferably at least 99%.

Where the clumping material is a starch-based extrudate, the starch-based extrudate has at least 5%, preferably at least 10%, and more preferably at least 15% by extrudate weight of an extrusion starch modified water-soluble binder clumping agent that forms a flowable adhesive that flows outwardly from starch-based extrudate containing clumping particles wetted with urine or water. Where clumping particles are composed of such a starch-based extrudate, the starch-based extrudate clumping particles are starch-based extrudate containing clumping particles each composed of at least 40%, preferably at least 50%, and more preferably at least 60% of starch-based extrudate by clumping particle weight.

In one preferred embodiment, the litter is a blend that contains at least 10% and preferably no more than 40%, preferably at least 15% and preferably no more than 35%, by litter blend weight of the starch-based extrudate clumping particles which are each composed at least 40%, preferably at least 50%, more preferably at least 60% starch-based extrudate by clumping particle weight and which also contain at least 5%, preferably at least 10%, and more preferably at least 15% of the extrusion starch modified water-soluble binder clumping agent by starch-based extrudate weight. In a preferred embodiment where the clumping particles are composed of a starch-containing clumping material that preferably is a starch-based extrudate clumping material, the litter blend is made up no more than about 20%±5% by weight of the litter with non-clumping particles making up at least 45%, preferably at least at least 50%, preferably at least 60%, more preferably at least 70%, and even more preferably no more than about 80%±5% of the litter. The starch-based extrudate containing clumping particles absorb at least four times starch-based extrudate weight, preferably at least five times starch-based extrudate weight, and more preferably between four to six times starch-based extrudate weight in water or urine.

In one such embodiment, the starch-based extrudate clumping particles are extruded sorbent pellets that absorb at least four times extruded pellet weight, preferably at least five times extruded pellet weight, and more preferably between four to six times extruded pellet weight in urine or water. These extruded sorbent pellet clumping particles are advantageously round or rounded thereby reducing tracking by being smoother and more difficult for a cat's paw to pick up. In another such embodiment, the starch-based extrudate clumping particles are formed of inner substrate particles coated or plated with even smaller starch-based extrudate particles that absorb at least four times starch-based extrudate weight, preferably at least five times starch-based extrudate weight, and preferably between four to six times starch-based extrudate weight in urine or water. These coated substrate clumping particles are advantageously round or rounded thereby also reducing tracking by being smoother and more difficult for a cat's paw to pick up. Where the litter is a blend that includes starch-based extrudate containing clumping particles, the clumps produced are shed-resistant clumps having a clump retention rate of at least 97%, preferably at least 98%, and more preferably at least 99%.

### DRAWING DESCRIPTION

One or more preferred exemplary embodiments of the invention are illustrated in the accompanying drawings in which like reference numerals represent like parts throughout and in which:

FIG. 1 is a fragmentary cross-section elevation view of clumping particles and non-clumping particles of a low tracking clumping litter of the present invention in a litter box depicting packing of smaller clumping particles in between adjacent larger non-clumping particles below the surface of the litter that minimizes the number of smaller clumping particles on the surface of the litter that can be tracked out of the box while forming clumps on the surface that can easily be scooped out;

FIG. 2 is a top view of another preferred low tracking clumping litter of the invention disposed in a litter box that is a dual component litter having a plurality of pairs of different types of clumping and non-clumping particles where sizes of the clumping particles are smaller than sizes of the non-clumping particles for helping to reduce tracking;

FIG. 3 is a front elevation view of a litter particle tracking effectiveness tool used to assess tracking effectiveness of litter;

FIG. 4 is a rear elevation view of the litter particle tracking effectiveness tool of FIG. 3;

FIG. 5 presents Table 1, which is a table setting forth litter particle material type, particle size ranges by sieve size, bulk density, and the respective formulations of Low Tracking Litter Product Trial Formulation Nos. 1-6 in weight percentages;

FIG. 6 presents Table 2, which is a table providing particle size distributions of (a) preferred types of non-clumping and non-clumping litter particles used in at least one of the Low Tracking Litter Product Trial Formulations, and (b) Low Tracking Litter Product Trial Formulation Nos. 1-6;

FIG. 7 presents Table 3, which is a table providing for each one of Low Tracking Litter Product Trial Formulation Nos. 1-6: the density, pre-drop clump weights for clumps 1 and 2, and post-drop clump weight of clump 1 dropped at 10 minutes after clump formation, post-drop clump weight of clump 2 when dropped at 30 minutes after clump formation, the clump retention rate of clump 1 when dropped at 10 minutes after clump formation, and the clump retention rate of clump 2 when dropped at 30 minutes after clump formation; and

FIG. 8 presents Table 4, which is a table providing the litter particle tracking effectiveness test results in numbers of particles per square inch of tracking pad surface area for Low Tracking Litter Product Trial Formulation Nos. 1-6 and four commercially available litters (for comparison).

Before explaining one or more embodiments of the invention in detail, it is to be understood that the invention is not limited in its application to the details of construction and the arrangement of the components set forth in the following description and figures. The invention is capable of other embodiments or being practiced or carried out in various ways. Also, it is to be understood that the phraseology and terminology employed herein is for the purpose of description and should not be regarded as limiting.

### DETAILED DESCRIPTION

### Introduction

Cat litter typically is manufactured either to be a non-clumping litter, which does not clump when its particles are wetted with urine or another aqueous liquid, or a clumping litter, which forms clumps when exposed to urine or another aqueous liquid, e.g., water, that wets particles of the clumping litter. As discussed in more detail below, non-clumping and clumping litter are formulated very differently from one another.

Non-clumping litter is typically formulated with larger sized litter particles, typically larger than 2 millimeters or 2000 microns (sieve 10) in size, that results in relatively loose packing of the litter when poured into a litter box producing relatively large voids between adjacent particles that desirably prevent urine from pooling on top of the litter and making a gooey mess. Non-clumping litter is formulated with these large sized litter particles so that the voids that form between them are large enough in size and number to define channels or passages in the litter so urine from an animal like a cat using the litter box can relatively rapidly traverse downwardly through them towards the bottom of the box. This prevents the urine from pooling on top and creating a gooey mess on top of the litter.

The relatively large sized particles used in non-clumping litter tend to reduce tracking as they are less likely to be carried out of the litter box. This is because these larger sized particles are large enough so as not to become easily embedded in the paws of a cat using the litter. And because these larger particles are also heavier, they also tend not to be readily picked up by the fur of the cat during use of the litter.

Clumping litter is typically formulated with smaller sized litter particles in comparison to non-clumping litter. The use of litter particles having smaller sizes than used in non-clumping litter results in tighter packing of the particles, which avoids the creation of larger passage and channel forming voids desired in non-clumping litter that would ordinarily allow urine from a cat to traverse downwardly through the litter towards the bottom of the litter box. The use of smaller sized particles in clumping litter relatively tightly packs them together in the box reducing the size of any voids formed between adjacent litter particles which prevents urine from rapidly flowing downwardly through these smaller voids. Because clumping litter contains clumping particles, urine wetting the clumping particles in and along these voids causes them to rapidly swell quickly plugging up these voids trapping the urine at or near the surface of the litter. Trapping the urine at or near the clumping litter's surface ensures that the urine is absorbed by litter particles at or near the litter's surface and that the urine-wetted litter particles form a clump on the surface of the litter that can easily be scooped out of the litter box.

When a cat urinates, it typically is at a rate of about 1 milliliter of urine per second. Because the use of smaller litter particles in clumping litter traps the urine at or near the litter's surface, it causes clumping material of the clumping particles in the litter to become sufficiently wetted with urine to activate the clumping material causing an expanding ball-like clump of wetted litter particles to form. During activation, the clumping material of each wetted clumping particle swells and becomes sticky causing it to adhere to one or more adjacent litter particles causing them to clump together. The urine becomes absorbed by the particles that form the clump locking up the urine in the clump and preventing it from flowing downwardly towards the bottom of the box.

This must occur nearly instantaneously when the urine makes contact with the clumping litter, otherwise the urine will flow downwardly towards the bottom of the litter box, resulting in a gooey mess at the bottom of the box. To facilitate clumping and obstruct the urine from flowing to the bottom, the smaller particles used in clumping litter include clumping particles whose clumping material expands immediately upon wetting to plug any voids between litter particles near the surface of the litter. Through plugging of the voids, it prevents the urine from flowing downwardly and redirects urine flow, so it remains at or near the top of the litter where it wets more and more clumping particles at or near the top of the litter forming an ever-expanding ball-like clump on top of the litter that enables it to be easily scooped out.

Generally, manufacturers of clumping cat litters have created litters with particle sizes less than 3350 microns (3.35 mm or 0.132 inches) (see, e.g., Hughes, U.S. Pat. No. 5,000,115) and in others having particle sizes less than 2000 microns (2.0 mm or 0.079 inches) (see, e.g., Kuras, U.S. Pat. No. 11,026,397). Both Hughes and Kuras teach the use of components with a preponderance of sizes less than 3500 microns (3.5 mm or 0.138 inches) and both also used clumping and non-clumping components of similar small sizes such that both possess poor tracking characteristics. Among other things, these patents teach the use of a pre-mixture surface area proxy associated with components having similar particle sizes and assumptions of similar shapes. Most prior art clumping litter used products of similar size distributions for the components they blend to improve consistency of clumping and for ease of blending.

Traditionally, attempts at making clumping litter having larger particles led to a litter that clumped inconsistently, and thus was not commercially viable.

Clumping litter formulations often include clumping agents, absorbent materials, non-absorbent components, and often also include non-clumping components. Clumping agents generally include, but are not limited to, sodium bentonite which is a water absorbing swelling clay that can absorb up to six times its weight in water, gums, carboxymethyl cellulose, acrylics, and/or high pressure extruded grains. Absorbent components of litter generally include, but are not limited to, calcium bentonite, starches, walnut shells, paper, products containing cellulose and perlite. Non-absorbent components include sand as well as a variety of other types of non-absorbent products. Some clumping agents are plated or coated onto other particles. For example, sodium bentonite can be coated or plated onto perlite granules or particles, guar gum can be applied to distiller dried grains, and guar gum can be applied to cellulose products.

While the above-described clumping litters enable clumps to be formed in the litter when exposed to urine that can easily be removed, the smaller sized particles used in clumping litter results in increased tracking of the litter outside of the litterbox. Improvements to clumping litters are therefore desirable.

It would thus be advantageous to have clumping litter formulations having very low tracking characteristics without sacrificing clumping ability, clumping efficiency, or clump integrity. It is also desirable to have a clumping litter that not only is low tracking, but which also minimizes the amount of spent litter particles that are shed from the clump while the clump is being removed from the litter box.

What is needed is a clumping litter formulated with a blend of larger non-clumping particles and smaller clumping particles whose respective particle sizes are selected to minimize tracking of litter particles while ensuring easily scoopable clumps form on top. As discussed in more detail below, such a low-tracking clumping litter is formulated to configure the litter when poured into a litter box so that the top surface of the litter is substantially completely formed of larger non-clumping particles to minimize tracking and the voids between larger non-clumping particles below the surface are packed with smaller clumping particles that trap urine at or near the surface so clumps of litter are formed on top that are easily scooped out.

### Low Tracking Clumping Cat Litter

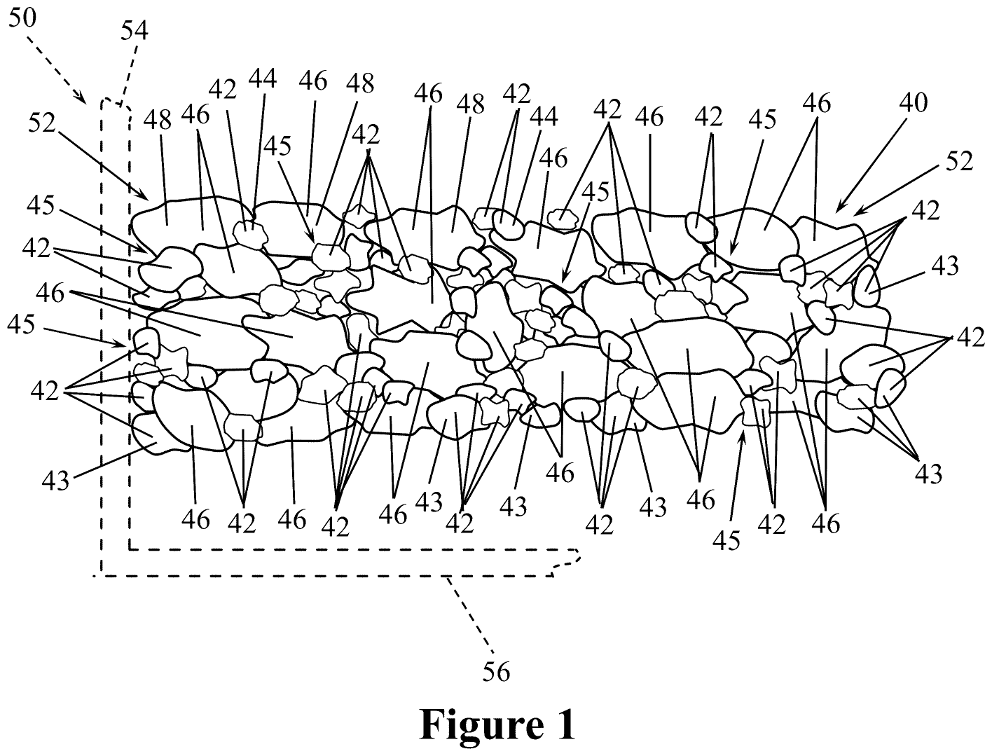

FIG. 1 illustrates a cross-section of a preferred low tracking clumping litter 40 of the present invention disposed in a litter box 50 having at least one side 54 and a bottom 56 formulated with a blend of smaller clumping particles 42 of a clumping material 44 and larger non-clumping particles 46 of a non-clumping material 48 whose respective particle sizes are selected to minimize tracking of litter particles while ensuring easily scoopable clumps of litter particles 42, 46 form on a top surface 52 of the litter 40 when a cat using the litter box 50 urinates on the surface 52 of the litter 40. As discussed in more detail below, such a low-tracking clumping litter 40 is formulated to configure the litter 40 so that upon being poured into a litter box 50 the top surface 52 of the litter 40 is substantially completely formed of harder to pick up larger non-clumping particles 46 to minimize tracking and the voids 45 that form between larger non-clumping particles below the surface are packed with smaller clumping particles 42 to trap urine at or near the surface 52 so clumps of litter particles 42, 46 are formed on top 52 so it can be easily scooped out of the box 50.

The low tracking clumping litter 40 preferably is a dry blend of (a) a granular clumping component composed of at least a plurality of pairs of, i.e., at least three, at least partially water absorbent clumping litter particles 42, which are partially or substantially completely composed of a clumping material 44, and which have varying particle sizes that fall within a clumping particle size range for the clumping component, and (b) a granular non-clumping component composed of at least a plurality of pairs of non-clumping litter particles 46, which are composed of a non-clumping material 48, and which have varying particle sizes that fall within a non-clumping particle size range for the non-clumping component. The preferred low tracking clumping litter 40 depicted in FIG. 1 is a dry blend of (a) a single granular clumping component composed of at least a plurality of pairs of, i.e., at least three, absorbent clumping litter particles 42, all of which are composed of the same clumping material 44, and which have varying particle sizes that fall within clumping particle size range, and (b) a single granular non-clumping component composed of at least a plurality of pairs of non-clumping litter particles 46, all of which are composed of the same non-clumping material 48, and which have varying particle sizes that fall within non-clumping particle size range. The clumping particles 42 are composed of a clumping material 44 which can and preferably is or does include a clumping agent. The non-clumping particles 46 can be and preferably are water absorbent, such as by preferably being made of a water absorbent material 48 that therefore is urine absorbent.

The litter 40 is formulated such that at least a substantial portion of the clumping particles 42 have particle sizes sufficiently smaller than the non-clumping particles 46 to configure the litter 40 so (a) when poured into a litter box 50 that its top surface 52 is substantially completely formed of larger non-clumping particles 46 advantageously minimizing tracking, and (b) voids 45 created between adjacent non-clumping particles 46 just below the surface 52 are packed with smaller clumping particles 42 thereby advantageously causing easily-scoopable clumps to form on or near the surface 52 during animal use of the litter. In a preferred formulation of the litter 40, all of the clumping particles 42 have particle sizes no greater than the smallest particle size of the non-clumping particles 46 and can be formulated with all of the clumping particles 42 smaller than the non-clumping particles 46. As discussed in more detail below, such clumps are composed of at least a plurality of pairs of, i.e., at least three, wetted clumping particles 42 which can and preferably also includes at least a plurality of pairs of, i.e., at least three, wetted non-clumping particles 46.

As discussed in more detail below, a low tracking clumping litter 40 of the present invention is formulated so (a) substantially all of its clumping particles 42 have a sufficiently small particle size, preferably no larger than 2000 microns and more preferably no larger than about 1700 microns, and a substantial portion, preferably at least about 75% and preferably substantially all, of the clumping particles 42 are smaller in size than the litter's non-clumping particles 46, and (b) its non-clumping particles 46 have a particle size sufficiently large enough, preferably at least 1500 microns and more preferably at least about 1700 microns, to prevent non-clumping particles 46 from getting stuck in paws of a cat using the litter 40. Such a litter 40 preferably is further formulated to have clumping particles 42 with a size no smaller than 200 microns, preferably no smaller than 250 microns, and more preferably no smaller than about 500 microns and has non-clumping particles no larger in size than about 5500 microns, preferably no larger than 5000 microns and more preferably no larger than about 4750 microns.

The litter 40 is formulated with a weight percentage of clumping particles 42 significantly lower than the weight percentage of the non-clumping particles 46 to produce a litter 40 which is not just a low tracking clumping litter in accordance with the present invention, but which also is relatively lightweight compared to prior art clumping litters. This advantageously produces a lightweight low tracking clumping litter 40 that also is more economical to make because the litter 40 is made up of no more than 45%, preferably no more than 40%, and more preferably no more than about 30% by litter weight of the more expensive clumping particles 42 with the remainder of the litter 40 preferably being composed of non-clumping litter particles 46. In one formulation, the litter 40 contains no more than 45% of the clumping particles 42 and at least 55% of the non-clumping particles 46. In another formulation, the litter 40 contains no more than 40% of the clumping particles 42 and at least 60% of the non-clumping particles 46. In a further formulation, the litter 40 contains no more than about 30% of the clumping particles 42 and at least about 70% of the non-clumping particles 46.

A preferred litter 40 is formulated to have between 10% and 45% of the clumping particles 42 and of between 55% and 90% of the non-clumping particles 46 by weight of the litter 40. Another preferred litter 40 contains between 15% and 40% of the clumping particles 42 and between 60% and 85% of the non-clumping particles 46. An especially preferred litter 40 is composed of about 30%±5% of the clumping particles 42 and about 70%±5% of the non-clumping particles 46. Such a litter 40 formulated in accordance with these clumping and non-clumping litter particle weight percents and/or weight percent ranges advantageously helps produce a lightweight low tracking clumping litter 40 in accordance with the present invention that has a desirably low bulk density of between 28 lbs/ft³ and 40 lbs/ft³ and preferably between about 32 lbs/ft³ and about 38 lbs/ft³.

A litter 40 having the aforementioned clumping and non-clumping litter particle sizes and/or clumping and non-clumping particle size ranges, clumping and non-clumping particle weight percents and/or clumping and non-clumping particle weight percent ranges, bulk densities and/or bulk density ranges is formulated to contain at least a minimum amount, but enough, of the more expensive clumping particles 42 having particle sizes sufficiently small enough relative to a greater amount of inexpensive larger non-clumping particles 46 that configures the litter 40 so that when the litter 40 is poured into a litter box 50 gravity causes the clumping particles 42 to automatically flow into voids 45 between and underlying adjacent non-clumping particles 46 leaving a layer of the non-clumping particles 46 on top forming the top surface 52 of the litter 40 in the box 50 that is substantially completely composed of the larger heavier tracking-resistant non-clumping particles 46. Because the clumping litter particles 42 include particles 42 sufficiently smaller in size than the smallest sized non-clumping particles 46, it configures the litter 40 so that pouring of the litter 42 into a litter box 50 automatically causes clumping particles 42 to become packed into voids 45 below the surface 52 that are disposed between and underneath larger non-clumping particles 46 which block downward urine flow trapping urine on or near the surface 52 ensuring scoopable clumps of litter particles 42, 46 form on the surface 52 during litter use by a cat. The clumping particles 42 that flow between the non-clumping particles 46 during pouring of the litter 40 into the litter box 50 sufficiently fill voids 45 between the particles 46 disposed below the litter's surface 52 advantageously blocks urine from a cat using the litter 40 from flowing through these voids 45 downwardly towards the bottom 56 of the box 50 thereby trapping the urine near the surface 52 so clumps form on top 52.

By virtue of the litter 40 being configured to automatically form a top surface 52 of litter 40 in the litter box 50 substantially completely composed of larger non-clumping particles 46, tracking is reduced and preferably minimized because the non-clumping particles 46 are formulated with a minimum particle size of at least 1700 microns so that the smallest sized non-clumping particles 46 are large enough to avoid being picked up by the paws of a cat walking on the surface 52 of the litter 40 in the litter box 50 during litter use. By virtue of the clumping particles 42 flowing downwardly between and underneath non-clumping particles 46 during pouring of the litter 40 into the box leaving the surface 52 of the litter 40 in the box 50 composed substantially completely of larger non-clumping particles 46, tracking is further reduced and preferably further minimized because the number of smaller stickier clumping particles 42 disposed at or along the surface 52 is advantageously minimized.

Because the larger non-clumping particles 46 are also heavier and not sticky like clumping particles 42 can be and typically are, the larger non-clumping particles 46 that form the top surface 52 of the litter 40 also are less likely to cling to the fur of a cat using the litter 40. Because the non-clumping particles 46 can be and preferably are at least partially composed of a non-clumping material 48 that is or includes an anti-static material, such as calcium bentonite, walnut shells, or another type of anti-static non-clumping material, tracking is further minimized because the non-clumping particles 46 are anti-static minimizing and preferably preventing a cat's fur from picking up non-clumping particles 46 during litter use due to electrostatic attraction.

This results in the litter 40 being advantageously configured to minimize the number of smaller clumping particles 42, which are stickier than non-clumping particles 46 and can more readily adhere to a cat using the litter 40, disposed on or along the litter's surface 52 and maximize the number of larger, heavier, and less sticky non-clumping particles 46 disposed on or along the litter's surface 52 thereby producing a low tracking litter 40 in accordance with the present invention having a desirably low litter particle tracking effectiveness of no greater than 150 and preferably no greater than 100 litter particles being picked up, i.e., tracked, per square inch of the litter's surface 52 when tested using the litter particle tracking effectiveness test procedure set forth below. One or more preferred embodiments of the litter 40 discussed below are formulated and/or configured to have an even lower litter particle tracking effectiveness of no greater than 80 particles per square inch and which can even be no greater than about 60 particles per square inch.

This also results in the litter 40 having such a wide range of litter particle sizes ranging between 200 microns and 5500 microns, preferably between 250 microns and 5000 microns, and more preferably between about 500 microns and about 4750 microns being advantageously configured to have a better structural stability and most desirably a higher packing efficiency that more rapidly absorbs urine contacting clumping particles 42 packed in the voids 45 between non-clumping particles 46 at or adjacent the litter's surface 52 trapping the urine at or near the litter surface 52 ensuring that a clump of wetted litter particles 42, 46 will form on or adjacent the surface 52 making it easy to scoop and remove. Such a litter 40 formulated with clumping particles 42 having one of the aforementioned clumping particle size ranges and with non-clumping particles 46 having one of the aforementioned non-clumping particle size ranges results in the clumping particles 42 having a higher surface area-to-volume ratio compared to the non-clumping particles 46, which advantageously facilitates better moisture absorption and clump formation during use of the litter 40 by a cat.

As also discussed in more detail below, a low tracking clumping litter 40 in accordance with the present invention not only forms clumps of wetted clumping particles 42 and non-clumping particles 44 at or near the top surface 52 of the litter 40 in a litter box 50, but the clumps formed possess good cohesion and reduced shedding advantageously producing scoopable low-shedding clumps that have a clump retention rate of at least 95%, preferably at least 97% and more preferably at least 98% when tested in accordance at either 10 minutes or 30 minutes using the clump retention test procedure set forth below. Such low-shedding clumps formed with a low tracking clumping litter 40 of the present invention preferably also has a desirably high clump compression strength of at least 50 pounds per square inch, preferably at least 100 pounds per square inch and more preferably at least 200 pounds per square inch, such as where the clumps are dried and tested in accordance with the clump compression strength test procedure set forth below.

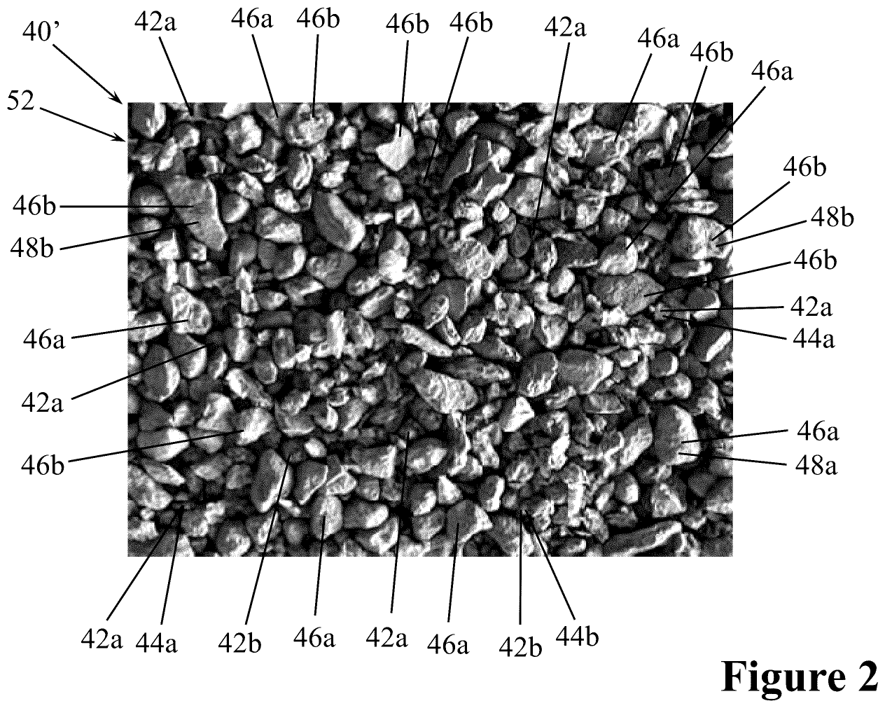

FIG. 2 illustrates a top view of another preferred low tracking clumping litter 40′ disposed in a litter box 50 that is a multicomponent low tracking clumping litter 40′ made of a blend of (a) (i) a plurality of clumping components with one component composed of clumping particles 42a and another component composed of clumping particles 42b that differ in some aspect from clumping particles 42a, and (ii) a plurality of non-clumping components with one component composed of non-clumping particles 46a and another component composed of non-clumping particles 46b that differ in some aspect from non-clumping particles 46a, (b) (i) multiple clumping components composed of a plurality of different clumping particles 42a, 42b, and (ii) a non-clumping component composed of non-clumping particles 46a or 46b, or (c) (i) multiple non-clumping components composed of a plurality of different non-clumping particles 46a, 46b, and (ii) a clumping component composed of clumping particles 42a or 42b. Clumping particles 42a, 42b preferably differ in some aspect, such as by being composed of different types of clumping materials 44a, 44b, having different particle sizes or different particle size ranges, having different densities, such as where particles 42a, 42b are made of the same material, or differing with respect to some other material characteristic thereof. Likewise, non-clumping particles 46a, 46b preferably also differ in some aspect, such as being composed of different types of non-clumping materials 48a, 48b, having different particle sizes or different particle size ranges, having different densities where the particles 46a, 46b are made of the same material, or differing with respect to some other material characteristic thereof. Although box 50 is not shown in FIG. 2, the litter 40′ also is disposed in a litter box 50 like the box 50 in FIG. 1.

The clumping particles 42a, 42b of each clumping component and the non-clumping particles 46a, 46b of each non-clumping component of a multicomponent low tracking clumping litter 40′ of the present invention respectively have varying particle sizes that fall within corresponding separate clumping and non-clumping component particle size ranges for each component which can in turn be used in defining a respective separate particle size distribution for each component. For example, where the litter 40′ has multiple clumping components, one of the clumping components is composed of clumping particles 42a having varying particle sizes falling within one clumping component particle size range, and another one of the clumping components is composed of clumping particles 42b having varying particle sizes falling within another clumping component particle size range. Likewise, where the litter 40′ has multiple non-clumping components, one of the non-clumping components is composed of non-clumping particles 46a having varying particle sizes falling within one non-clumping component particle size range, and another one of the non-clumping components is composed of non-clumping particles 46b having varying particle sizes falling within another non-clumping component particle size range. The varying particle sizes of the clumping particles 42a, 42b of each clumping component can also be used together with their respective particle size weight percentages to define a corresponding clumping component particle size distribution for particles 42a, 42b. Likewise, the varying particle sizes of the non-clumping particles 46a, 46b of each non-clumping component together with their respective particle size weight percentages can be used to define corresponding non-clumping component particle size distributions of particles 46a, 46b.

A low tracking clumping multicomponent litter 40′ formulated in accordance with the present invention is configured like litter 40 to have a desirably low litter particle tracking effectiveness in tracking no greater than 150 litter particles per square inch of the litter's surface 52, preferably no greater than 100 particles per square inch, more preferably no greater than 80 particles per square inch, and even more preferably no greater than about 60 particles per square inch. Such a litter 40′ advantageously is also configured like litter 40 to form clumps on or near the litter's top surface 52 that preferably are low-shedding clumps having (a) a desirably high clump retention rate of at least 95%, preferably at least 97% and more preferably at least 98% at 10 minutes and 30 minutes using the clump retention test procedure below, and/or (b) a desirably high clump compression strength of at least 50 pounds per square inch, preferably at least 100 pounds per square inch and more preferably at least 200 pounds per square inch. Each clump formed using a multicomponent litter 40′ is composed of at least a plurality of pairs of urine or water wetted clumping particles 42a and/or at least a plurality of pairs of urine or water wetted clumping particles 42b adhered together with at least a plurality of pairs of non-clumping particles 46a and/or 46b.

Suitable clumping materials which can be used for the clumping material 44 of clumping particles 42 of litter 40 or the clumping materials 44a and 44b of clumping particles 42a and 42b of multicomponent litter 40′ include a clumping clay, e.g., clumping smectite, preferably sodium bentonite, a starch-containing clumping material, a gum or gum-based clumping material, a carrageenan or carrageenan-based clumping material, a pectin or pectin-based clumping material, a gelatin or gelatin based clumping material, an alginate or alginate-based clumping material, gluten or gluten-based clumping material, a dextran or dextran-based clumping material, a clumping polymer or copolymer, an ester or ester-based clumping material, a superabsorbent polymer or superabsorbent polymer-based clumping material, derivates, combinations and mixtures thereof, clumping materials containing one or more of the aforementioned clumping materials as clumping agents as well as any other type of clumping material which causes clumping litter particles 42 or 42a and 42b and non-clumping particles 46 or 46a and 46b of litter 40 or 40′ to clump together when at least the clumping particles 42 or 42a and 42b are wetted with urine or water. Suitable gums or gum-based clumping materials include guar gum, xanthan gum, locust bean gum, gum arabic, gum karaya, gum tragacanth, gum ghatti along with derivates and mixtures thereof as well as other clumping materials that contain such a gum or gum-based clumping material as a clumping agent. Suitable polymers or copolymers include vinyl polymers, such as polyvinyl esters, polyvinyl esters, such as polyvinyl acetate, polyvinylpyrrolidone, polyvinyloxazolidone, polyvinylmethyloxazolidone, copolymers or mixtures thereof, as well as copolymers and mixtures thereof. Suitable starch-containing clumping materials include pregelatinized starch, dextrin, cassava, tapioca, physically, thermally and/or chemically modified starch clumping materials, other starch-containing clumping materials, as well as other clumping materials that contain one or more of these starch-containing clumping materials.

A preferred starch-containing clumping material suitable for use as a clumping material 44 of clumping particles 42 of litter 40 or the clumping material(s) 44a and/or 44b of clumping particles 42a and/or 42b of litter 40′ is a starch-based extrudate, referred to herein as a starch-based clumping agent, produced using an extruder, such as preferably a single screw extruder, from a starch-containing material, preferably a starch-containing admixture having a moisture content no greater than 25%, preferably no greater than 22%, more preferably no greater than about 18%, and which contains at least 40% starch, preferably at least 50% starch, more preferably at least about 60% starch by admixture weight, by extruding the starch-containing admixture at an extrusion pressure of at least 2000 pounds per square inch, preferably at least 2500 pounds per square inch, more preferably at least 3000 pounds per square inch, at an extrusion temperature of at least 100° C., preferably at least 120° C., more preferably at least 135° C., which modifies, preferably extrusion modifies, at least some of the starch in the admixture, such as by physical modification and/or thermal modification, through application of the extrusion pressure while the admixture is in the extruder, into a water soluble binder, preferably a cold water soluble binder, which is a clumping agent, in an amount of at least 5%, preferably at least 10%, and more preferably at least 15%, by starch-based extrudate weight, e.g., extruded pellet weight, in the starch-based extrudate extruded from the extruder. The starch-containing admixture preferably is composed of one or more cereal grains, such as wheat, corn, oats, rice, barley, sorghum, and/or millet; one or more tubers, e.g., yams, sweet potatoes, and/or another type of potato; and/or one or more legumes, such as lentils, chickpeas, peas, lupins, and beans, such as butter beans, haricot (navy) beans, cannellini beans, red kidney beans, adzuki beans, black-eyed beans and/or soybeans.

Such starch-based extrudate containing clumping litter particles 42 or 42a and/or 42b used in litter 40 or 40′ can be extruded sorbent clumping litter pellets 43, such as the extruded sorbent clumping litter pellets 43 of a clumping lightweight natural grass litter marketed and sold by Pioneer Pet Products, LLC of Cedarburg Wisconsin as SmartCat All Natural 100% Grass Lightweight Clumping Litter which can be grey in color, and which can have a composition, construction, configuration and/or made using a method of manufacture similar to or substantially the same as the extruded clumping litter pellets disclosed in one or more of commonly owned U.S. Pat. Nos. 11,013,211; 11,083,168; and 11,457,605 the entirety of each of which is expressly incorporated herein by reference. With continued reference to FIG. 1, these extruded sorbent clumping pellets 43 are rounded and/or substantially round so as to have a substantially smooth rounded outer surface absent of any rough or jagged surface features thereby making it less likely for a paw of a cat using the litter to pick them up thereby advantageously reducing tracking. Such substantially smooth round or rounded extruded sorbent pellets 43 are also less irritating for a cat when they are picked up or somehow become embedded in a paw of a cat. Clumping particles 42 or 42a and/or 42b that are extruded clumping litter pellets 43 are each preferably composed substantially completely of starch-based extrudate clumping material containing at least 5%, preferably at least 10%, more preferably 15% cold water-soluble binder clumping agent that absorbs at least four times, preferably at least five times, more preferably at least six times, and preferably between four and six times extruded clumping litter pellet weight in urine or water during litter use. The cold-water soluble binder clumping agent is cold water soluble by being water soluble at temperatures of between about 10 degrees Celsius and about 25 degrees Celsius or between about 50 degrees Fahrenheit and about 77 degrees Fahrenheit.

Such starch-based extrudate clumping material containing clumping litter particles 42 or 42a and/or 42b of litter 40 or 40′ can instead or also be composed of substrate particles coated or plated with starch-based extrudate clumping material containing at least 5%, preferably at least 10%, more preferably 15% cold water soluble binder clumping agent, such as by the substrates particles of each pellet 42 or 42a and/or 42b being coated or plated with finely sized particles, e.g., fines or powder, or finely sized pellets of this starch-based extrudate which are smaller, preferably significantly smaller, than the substrate particles, such as in the manner disclosed in commonly owned co-pending U.S. application Ser. No. 18/372,677, filed Sep. 25, 2023, the entirety of which is expressly incorporated by reference herein. The resultant starch-based extrudate coated substrate clumping particles 42 of litter 40 or the resultant starch-based extrudate coated substrate clumping particles 42a and/or 42b of litter 40′ can be constructed or configured to be substantially the same as or similar to the clumping granules made of substrate particles coated or plated with starch-based extrudate disclosed in commonly owned co-pending U.S. application Ser. No. 18/372,677, filed Sep. 25, 2023, the entirety of which is expressly incorporated by reference herein. Clumping particles 42 or 42a and/or 42b that are composed of substrate particles coated or plated with starch-based extrudate clumping material containing at least 5%, preferably at least 10%, more preferably 15% cold water-soluble binder clumping agent absorb at least four times, preferably at least five times, and more preferably between four and six times the weight of the starch-based extrudate clumping material in each clumping litter particle 42 or 42a and/or 42b in urine or water during use of such litter 40 or 40′. Such starch-based extruded coated substrate clumping particles 42 also are rounded or substantially round so as to be substantially smooth with the absence of any rough or jagged exterior surface features also making it less likely for a paw of a cat using the litter to pick them up thereby advantageously reducing tracking. Such round or rounded substantially smooth starch-based extruded coated substrate clumping particles 42 are not only less likely to become embedded in a paw of a cat using the litter 40 or 40′, but also advantageously are less likely to cause irritation to the paw of the cat if for some reason any of these round or rounded substantially smooth starch-based extruded coated substrate clumping particles 42 do somehow become embedded in the paw of a cat.

Clumping particles 42 or 42a and/or 42b of such litter 40 or 40′ can also be made of substrate particles plated or coated with clumping materials 44 or 44a and/or 44b partially or completely composed of one or more of the other types of suitable clumping materials disclosed above. As such, a litter 40 or 40′ of the present invention can also and/or instead use clumping particles 42 or 42a and/or 42b made of substrate particles coated or plated with a different starch-containing clumping material such as pregelatinized starch, a dextrin, a gum, such as preferably guar gum, a clumping clay, such as preferably sodium bentonite, carrageenan, a pectin, another one of the above-disclosed types of clumping materials and/or clumping agents, another type of clumping material or clumping agent as well as derivates and/or mixtures thereof.

Suitable non-clumping materials 48 or 48a and 48b from or of which the non-clumping particles 46 or 46a and 46b of litter 40 or 40′ are at least partially or substantially completely composed include a non-clumping absorbent smectite, such as calcium bentonite, attapulgite, Fullers Earth, sepiolite and/or kaolinite; plastic, e.g., ground plastic particles; rubber, e.g., comminuted scrap tire particles; non-absorbent glass, e.g., glass beads, glass granules or glass pellets that can have a smooth exterior or texture; absorbent wood, including wood pellets, sawdust, sawdust pellets, wood shavings, bark, comminuted wood particles, including granules, pellets or balls made at least in part of wood, or the like; paper, e.g., granules, pellets, or balls composed at least in part of paper which preferably are absorbent; other types of cellulosic particles, balls, granules or the like which can be and preferably are also absorbent; sand, e.g., non-absorbent silica sand; perlite; plant shells or hulls, such as comminuted shells or hulls, e.g., ground shells or hulls, from walnuts, e.g., walnut shells, hazelnuts, e.g., hazelnut shells, cashews, e.g., cashew shells, almonds, e.g., almond shells, macadamia nuts, e.g., macadamia nut shells, peanuts, e.g., peanut shells or outer hulls from peanuts, Brazil nuts, e.g., Brazil nut shells, pine nuts, e.g., pine nut shells or outer hulls, and/or pecans, e.g., pecan shells or hulls; and other types of non-clumping materials which can be water and urine absorbent or non-absorbent. Where the non-clumping particles 46 or 46a and/or 46b are at least partially made of paper or a clumping material at least partially composed of paper, the non-clumping particles 46 or 46a and/or 46b can be made of paper fibers, such as preferably recycled and/or deinked paper fibers, and more preferably post-consumer waste deinked and recycled paper fibers.

Non-clumping particles 46 or 46a and/or 46b of litter 40 or 40′ can also be made of substrate particles plated or coated with non-clumping materials 48 or 48a and/or 48b partially or completely composed of one or more of the other types of suitable non-clumping materials disclosed above. As such, a litter 40 or 40′ formulated and/or configured in accordance with the present invention can use non-clumping particles 46 or 46a and/or 46b made of substrate particles coated or plated with one or more non-clumping materials, such as non-clumping smectite particles or non-clumping clay particles, plastic particles, rubber particles, glass particles, wood particles, paper particles, cellulose particles, perlite particles, ground plant shell particles and/or ground plant hull particles, and the like as well as mixtures thereof which can be and preferably are adhered to the substrate particles with a binder, e.g., a glue or an adhesive, to form such non-clumping coated substrate non-clumping particles 46 or 46a and/or 46b after curing of the binder.

In a preferred multicomponent litter 40′, each non-clumping particle 46a and/or 46b of the litter 40′, even where made of substrate particles coated with a non-clumping material, can be at least partially composed of a non-clumping material 48a and/or 48b that is or includes an anti-static material, such as calcium bentonite, walnut shells, other types of ground or comminuted plant hulls and shells, wood, e.g., sawdust, wood fibers or particles of wood, carbon, e.g., carbon black, carbon fiber, graphene, conductive polymer(s), metallic material(s), e.g., in comminuted or powdered form, silicone-based antistatic material, a conductive oxide or conductive oxide material, e.g., in comminuted or powdered form, another type of anti-static material or a combination of one or more of these antistatic materials. Such antistatic materials can take the form of a powder, coating, spray, treatment or other form used as, mixed with, and/or applied to non-clumping material 48 used in making non-clumping particles 46. If desired, each non-clumping particle 46a and/or 46b of the litter 40′ can be and preferably is at least partially composed of a non-clumping material 48a and/or 48b can be coated with an anti-static material that is (a) an electrically conductive material, e.g., comminuted walnut shells, carbon, carbon black, carbon fiber and/or graphene, (b) a dissipative material that dissipates static electricity, and/or (c) an insulative material with an anti-static treatment.

In a preferred multicomponent litter 40′, each one of the non-clumping particles 46a and/or 46b can be and preferably is at least partially composed of a respective non-clumping material 48a and/or 48b that is or includes an anti-static material, such as calcium bentonite, walnut shells, carbon, carbon fiber, or another type of anti-static material. Other types of antistatic materials which can be used include wood, e.g., sawdust, wood fibers or particles of wood, other types of plant hulls and shells, carbon, e.g., carbon black, carbon fiber, graphene, conductive polymer(s), metallic material(s), e.g., in comminuted or powdered form, silicone-based antistatic material, a conductive oxide or conductive oxide material, e.g., in comminuted or powdered form, another type of anti-static material or a combination of one or more of these antistatic materials. Such antistatic materials can take the form of a powder, coating, spray, treatment or other form used as, mixed with, and/or applied to non-clumping material 48 used in making non-clumping particles 46.

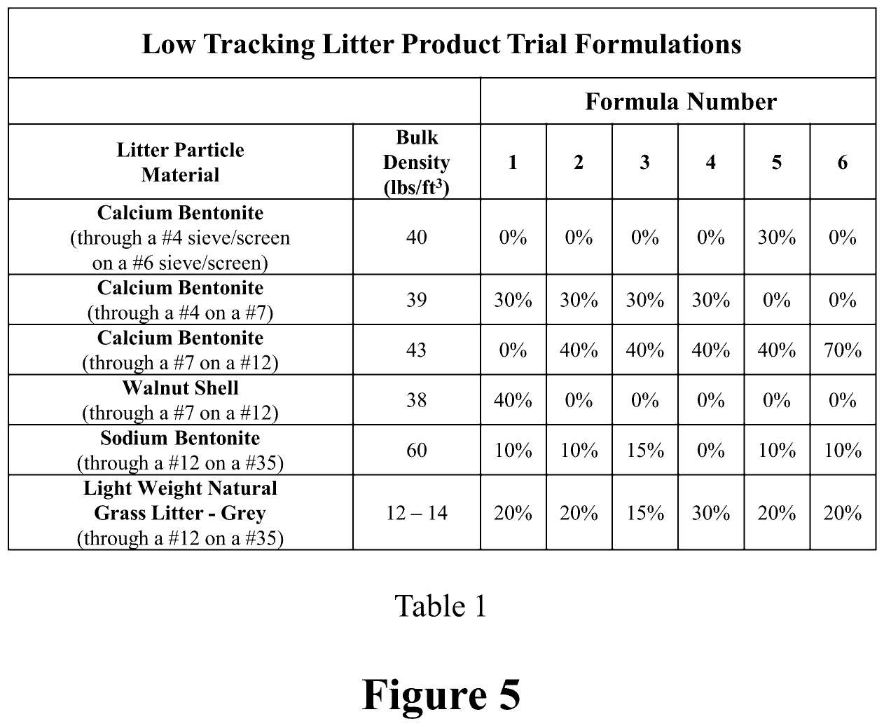

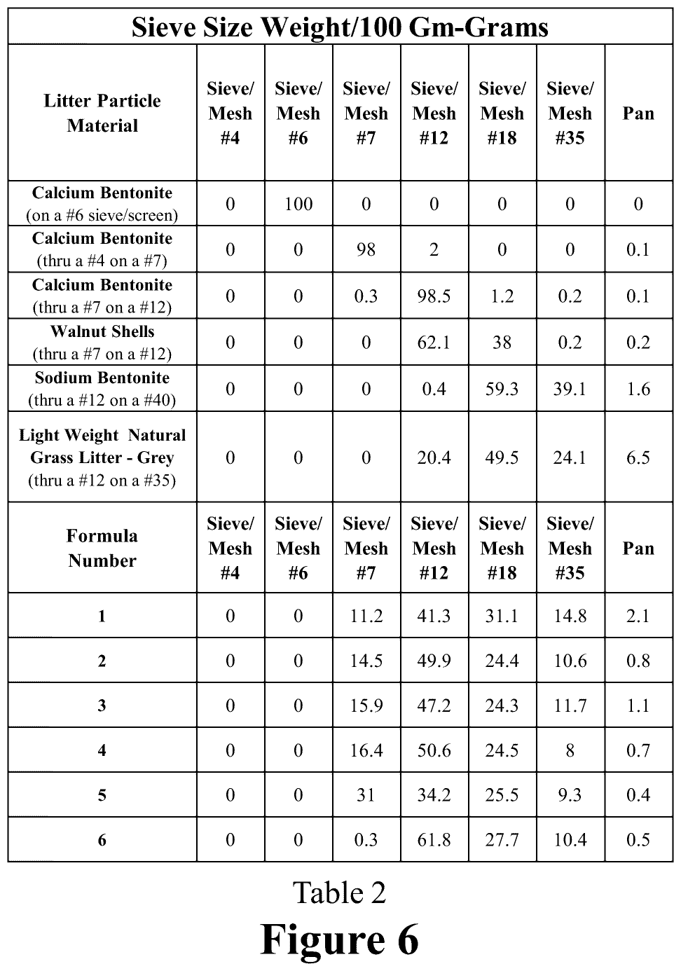

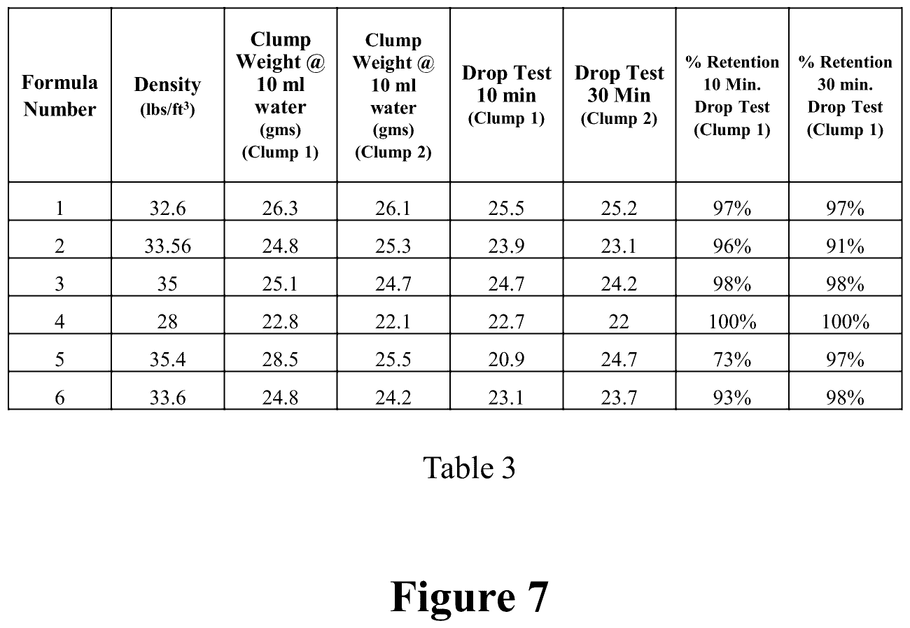

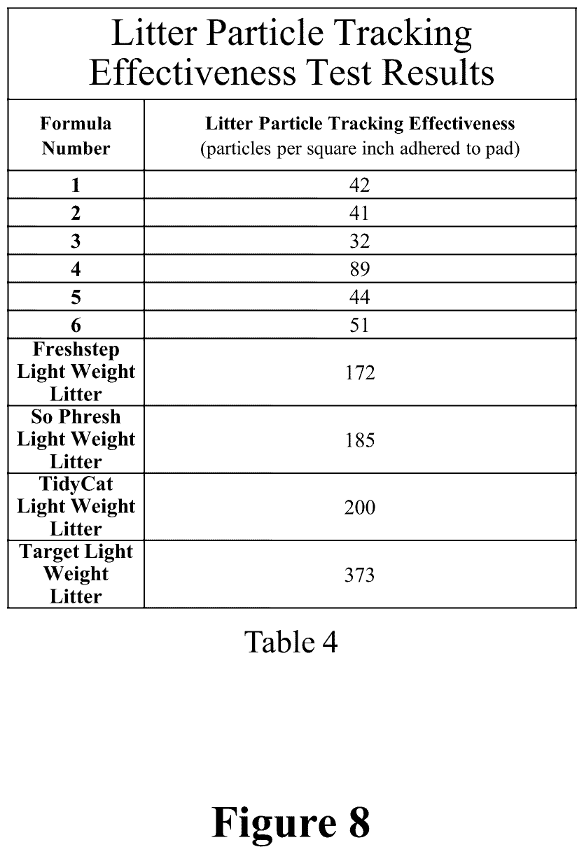

With reference to FIGS. 5-8, six preferred but exemplary trial blend formulations of a multicomponent low tracking clumping litter 40′ of the present invention are presented in Table 1 of FIG. 5, their respective particle size distributions are presented in Table 2 of FIG. 6, their respective clump retention rates are presented in Table 3 of FIG. 7, and their respective litter particle tracking effectiveness numbers are presented in Table 4 of FIG. 8.

Trial Formula No. 1 is a low tracking clumping litter blend formulation composed of (a) about 30% by litter weight of non-clumping calcium bentonite litter granules 46a having a bulk density of about 39 lbs/ft³ with particle sizes that pass through a #4 mesh screen and which are retained on a #7 screen having a particle size range of between about 2800 microns and about 4750 microns, (b) about 40% non-clumping comminuted or crushed walnut shells having a bulk density of about 38 lbs/ft³ comminuted into particles 46b having sizes which pass through a #7 mesh screen and which are retained on a #12 screen having a particle size range of between about 1700 microns and about 2800 microns, (c) about 10% clumping sodium bentonite granules 42a having a bulk density of about 60 having a bulk density of about 39 lbs/ft³ with particle sizes that pass through a #12 screen and are retained on a #35 screen having a particle size range of between about 500 microns and about 1700 microns, and (d) about 20% of starch-based extrudate clumping particles 42b, preferably extruded starch-based absorbent clumping litter pellets 43, preferably composed of at least 5%, preferably at least 10%, and more preferably at least 15% by extrudate weight of extrusion-modified starch-based water-soluble binder clumping agent referred to in the tables as Light Weight Natural Grass Litter pellets 43 with a bulk density of between 12 and 14 lbs/ft³ whose granules 46a have particle sizes that pass through a #12 screen and are retained on a #35 screen thereby having a particle size range of between about 500 microns and about 1700 microns. With specific reference to Table 2 of FIG. 6, Formula No. 1 has about 11.2% of its particles 42a, 42b, 46a and/or 46b retained on a #7 mesh screen having a particle size of between about 2800 microns and about 4750 microns, about 41.3% of its particles 42a, 42b, 46a and/or 46b retained on a #12 screen having a particle size of between about 1700 microns and about 2800 microns, about 31.1% of its particles 42a, 42b, 46a and/or 46b retained on a #18 mesh screen having a particle size of between about 1000 microns and about 1700 microns, and about 14.8% of its particles 42a, 42b, 46a and/or 46b retained on a #35 mesh screen having a particle size of between about 500 and about 1000 microns. This trial blend formulation produces a low tracking clumping litter 40′ of the present invention which preferably also is lightweight, having a bulk density between 25-42 lbs/ft³, preferably between 30-37 lbs/ft³, and more preferably about 32.6 lbs/ft³, which has a litter particle tracking effectiveness of no more than 75 particles per square inch, preferably no more than 50 particles per square inch, and preferably no more than about 42 particles per square inch, and which forms shed-resistant clumps when its litter particles 42a, 42b, 46a, 46b are wetted with urine that have a clump retention rate of at least 95% and preferably at least 97% in the 10 minute drop test and in the 30 minute drop test.

If desired, a litter having a blend formulation similar to Trial Formula No. 1 can vary the weight percentages of the clumping and non-clumping constituents that make up the above multicomponent litter blend 40′. One such litter 40′ can be composed of between about 5% and about 65% calcium bentonite non-clumping litter particles 46a, between about 65% and 5% comminuted or crushed walnut shell non-clumping litter particles 46b, between about 5% and about 25% sodium bentonite clumping litter particles 42a, and between about 25% and about 5% starch-containing clumping particles 42b which preferably are starch-based extrudate clumping particles 42b which more preferably are starch-based extrudate clumping pellets 43. Another such litter 40′ can be composed of between about 25% and about 45% calcium bentonite non-clumping litter particles 46a, between about 45% and about 25% comminuted or crushed walnut shell non-clumping litter particles 46b, between about 5% and about 15% sodium bentonite clumping litter particles 42a, and between about 25% and about 15% starch-containing clumping particles 42b which preferably are starch-based extrudate clumping particles 42b which more preferably are starch-based extrudate clumping pellets 43. One of the non-clumping particles 46a or 46b have varying particle sizes falling in a first non-clumping particle size range of between about 1400 microns and about 3400 microns, preferably between about 1500 microns and 2900 more preferably between about 1700 microns and about 2800 microns, and the other one of the non-clumping particles 46b or 46a can have varying particle sizes falling in a second non-clumping particle size range of between about 2500 microns and about 5500 microns, preferably between about 2700 microns and about 5000 microns, and more preferably between about 2800 microns and about 4750 microns. If desired, the non-clumping particles 46a, 46b can collectively make up a clumping particle size range with varying particle sizes ranging between 1400 microns and 5500 microns, preferably between 1500 microns and 5000 microns, and more preferably between 1700 microns and 4750 microns. The clumping particles 42a and/or 42b have varying particle sizes falling between about 200 microns and about 1900 microns, preferably between about 500 microns and about 1700 microns. If desired, the clumping particles 42a, 42b can collectively make up a clumping particle size range with varying particle sizes ranging between 200 microns and 2000 microns, preferably between 250 microns and 1900 microns, and more preferably between about 500 microns and about 1700 microns. The respective particle size distributions and litter bulk density can be similar or substantially the same as disclosed in the preceding paragraph for Trial Formula No. 1. The litter particle tracking effectiveness and clump retention rates preferably are also similar or substantially the same as disclosed in the preceding paragraph for Trial Formula No. 1.

Trial Formula No. 2 is a blend formulation composed of (a) about 30% by litter weight of non-clumping calcium bentonite granules whose particles 46a pass through a #4 mesh screen and which are retained on a #7 screen having a particle size range of between about 2800 microns and about 4750 microns, (b) about 40% non-clumping calcium bentonite granules whose particles 46b pass through a #7 mesh screen and which are retained on a #12 screen having a particle size range of between about 1700 microns and about 2800 microns, (c) about 10% clumping sodium bentonite granules whose particles 42a pass through a #12 screen and are retained on a #35 screen having a particle size range of between about 500 microns and about 1700 microns, and (d) about 20% extruded starch-based clumping litter pellets 42b, referred to in the tables as Light Weight Natural Grass Litter, composed of at least 5%, preferably at least 10%, and more preferably at least 15% extrusion-modified starch-based water-soluble binder clumping agent which pass through a #12 screen and are retained on a #35 screen having a particle size range of between about 500 microns and about 1700 microns. The calcium bentonite granules 46a have a bulk density of about 39 lbs/ft³, the calcium bentonite granules 46b have a bulk density of about 43 lbs/ft³, the sodium bentonite granules 42a have a bulk density of about 60 lbs/ft³, and the extruded starch-based absorbing pellets 42b have a bulk density of between 12 and 14 lbs/ft³. The litter 40′ of Formula Trial No. 2 has about 14.5% of its particles retained on a #7 mesh screen and having a particle size of between about 2800 and about 4750 microns, about 49.9% of its particles retained on a #12 screen and having a particle size of between about 1700 and about 2800 microns, about 24.4% of its particles retained on a #18 mesh screen, and having a particle size of between about 1000 and about 1700 microns, and about 10.6% of its particles retained on a #35 mesh screen, and having a particle size of between about 500 and about 1000 microns. This blend formulation produces a low tracking clumping litter 40′ which is lightweight, having a bulk density of between 25-42 lbs/ft³, preferably between 30-37 lbs/ft³, and more preferably about 33.56 lbs/ft³, which has a litter particle tracking effectiveness of no greater than 75 particles per square inch, preferably no greater than 50 particles per square inch, and preferably no greater than about 41 particles per square inch, and which forms shed-resistant clumps when wetted with urine that have a clump retention rate of at least 91% in the 30 minute drop test and preferably at least 96% in the 10 minute drop test.

If desired, a litter having a blend formulation similar to Trial Formula No. 2 can vary the weight percentages of the clumping and non-clumping constituents that make up the above multicomponent litter blend 40′. If desired, such a litter 40′ can be composed of between 0% and about 70% calcium bentonite non-clumping litter particles 46a, between about 70% and 0% calcium bentonite non-clumping litter particles 46b, between about 5% and about 15% sodium bentonite clumping litter particles 42a, and between about 25% and about 15% starch-containing clumping particles 42b, which preferably are starch-based extrudate clumping particles 42b which more preferably are starch-based extrudate clumping pellets 43. Another such litter 40′ can be composed of between about 25% and about 50% calcium bentonite non-clumping litter particles 46a, between about 45% and about 20% calcium bentonite non-clumping litter particles 46b, between about 5% and about 15% sodium bentonite clumping litter particles 42a, and between about 25% and about 15% starch-containing clumping particles 42b which preferably are starch-based extrudate clumping particles 42b which more preferably are starch-based extrudate clumping pellets 43. One of the non-clumping particles 46a or 46b have varying particle sizes falling in a first non-clumping particle size range of between about 1400 microns and about 3000 microns, preferably between about 1500 microns and about 2900 microns, and more preferably between about 1700 microns and about 2800 microns, and the other one of the non-clumping particles 46b or 46a can have varying particle sizes falling in a second non-clumping particle size range of between about 2500 microns and about 5500 microns, preferably between about 2600 microns and about 5000 microns, and more preferably between about 2800 microns and about 4750 microns. If desired, the non-clumping particles 46a, 46b can collectively make up a clumping particle size range with varying particle sizes ranging between about 1400 microns and about 5500 microns, preferably between about 1500 microns and about 5000 microns, and more preferably between about 1700 microns and about 4750 microns. The clumping particles 42a and/or 42b have varying particle sizes falling between about 200 microns and about 2000 microns, preferably between about 250 microns and about 1900 microns, and more preferably between about 500 microns and about 1700 microns. If desired, the clumping particles 42a, 42b can collectively make up a clumping particle size range with varying particle sizes or corresponding varying sized clumping particle size ranges with clumping particles ranging in particle size between about 250 microns and about 2000 microns. The respective particle size distributions and litter bulk density can be similar or substantially the same as disclosed in the preceding paragraph for Trial Formula No. 2. The litter particle tracking effectiveness and clump retention rates preferably are also similar or substantially the same as disclosed in the preceding paragraph for Trial Formula No. 2.

Formula No. 3 is a blend formulation composed of (a) about 30% by litter weight of non-clumping calcium bentonite granules 46a with a bulk density of about 39 lbs/ft³ having particle sizes that pass through a #4 mesh screen and which are retained on a #7 screen having a particle size range of between about 2800 microns and about 4750 microns, (b) about 40% non-clumping calcium bentonite granules 46b with a bulk density of about 43 lbs/ft³ having particle sizes that pass through a #7 mesh screen and which are retained on a #12 screen having a particle size range of between about 1700 microns and about 2800 microns, (c) about 15% clumping sodium bentonite granules 42a of a bulk density of about 60 lbs/ft³ having particle sizes that pass through a #12 screen and are retained on a #35 screen having a particle size range of between about 500 microns and about 1700 microns, and (d) about 15% of the extruded starch-based clumping litter pellets 42b of a bulk density between 12 and 14 lbs/ft³, referred to in the table as Light Weight Natural Grass Litter, which are composed of at least 5%, preferably at least 10%, and more preferably at least 15% extrusion-modified starch-based water-soluble binder clumping agent whose pellets 42b have particle sizes that pass through a #12 screen and are retained on a #35 screen having a particle size range of between about 500 microns and about 1700 microns. With specific reference to Table 2 of FIG. 6, Formula No. 3 has about 15.9% of its particles 42a, 42b, 46a, and/or 46b retained on a #7 mesh screen and having a particle size of between about 2800 microns and about 4750 microns, about 47.2% of its particles 42a, 42b, 46a, and/or 46b retained on a #12 screen and having a particle size of between about 1700 microns and about 2800 microns, about 24.3% of its particles 42a, 42b, 46a, and/or 46b retained on a #18 mesh screen, and having a particle size of between about 1000 microns and about 1700 microns, and about 11.7% of its particles 42a, 42b, 46a, and/or 46b retained on a #35 mesh screen, and having a particle size of between about 500 microns and about 1000 microns. This blend formulation produces a low tracking clumping litter 40′ in accordance with the invention that also is lightweight having a bulk density of between 25-45 lbs/ft³, preferably between 30-40 lbs/ft³, and more preferably about 35 lbs/ft³, which has a litter particle tracking effectiveness of no more than 50 particles per square inch, preferably no more than 40 particles per square inch, and more preferably no more than about 32 particles per square inch, and which forms shed-resistant clumps when wetted with urine that have a clump retention rate of at least 97% and preferably at least 98% in one and preferably both the 10 minute and 30 minute clump retention tests.

If desired, a litter having a blend formulation similar to Trial Formula No. 3 can vary the weight percentages of the clumping and non-clumping constituents that make up the above multicomponent litter blend 40′. If desired, such a litter 40′ can be composed of between about 20% and about 50% calcium bentonite non-clumping litter particles 46a, between about 50% and about 20% calcium bentonite non-clumping litter particles 46b, between about 10% and about 20% sodium bentonite clumping litter particles 42a, and between about 20% and about 10% starch-containing clumping particles 42b which preferably are starch-based extrudate clumping particles 42b which more preferably are starch-based extrudate clumping pellets 43. Another such litter 40′ can be composed of between 0% and about 70% calcium bentonite non-clumping litter particles 46a, between about 70% and 0% calcium bentonite non-clumping litter particles 46b, between about 10% and about 20% sodium bentonite clumping litter particles 42a, and between about 20% and about 10% starch-containing clumping particles 42b which preferably are starch-based extrudate clumping particles 42b which more preferably are starch-based extrudate clumping pellets 43. One of the non-clumping particles 46a or 46b have varying particle sizes falling in a first non-clumping particle size range of between about 1400 microns and about 3000 microns, preferably between about 1500 microns and about 2900 microns, and more preferably between about 1700 microns and about 2800 microns, and the other one of the non-clumping particles 46b or 46a can have varying particle sizes falling in a second non-clumping particle size range of between about 2500 microns and about 5500 microns, preferably between about 2700 microns and about 5000 microns, and more preferably between about 2800 microns and about 4750 microns. If desired, the non-clumping particles 46a, 46b can collectively make up a non-clumping particle size range with varying particle sizes ranging between about 1400 microns and about 5500 microns, preferably between about 1500 microns and about 5000 microns, and more preferably between about 1700 microns and about 4750 microns. The clumping particles 42a and/or 42b have varying particle sizes falling between about 200 microns and about 2000 microns, preferably between about 250 microns and about 1900 microns, and more preferably between about 500 microns and about 1700 microns. If desired, the clumping particles 42a, 42b can collectively make up a clumping particle size range with varying particle sizes or corresponding varying particle size ranges of the clumping particles 42a and 42b collectively ranging or being distributed between about 200 microns and about 2000 microns, between about 250 microns and about 1900 microns, and more preferably between about 500 microns and about 1700 microns. The respective particle size distributions and litter bulk density can be similar or substantially the same as disclosed in the preceding paragraph for Trial Formula No. 3. The litter particle tracking effectiveness and clump retention rates preferably are also similar or substantially the same as disclosed in the preceding paragraph for Trial Formula No. 3.

Trial Formula No. 4 is a blend formulation composed of (a) about 30% by weight of non-clumping calcium bentonite granules 46a with particle sizes that pass through a #4 mesh screen and which are retained on a #7 screen having a particle size range of between about 2800 microns and about 4750 microns, (b) about 40% non-clumping calcium bentonite granules 46b having particle sizes that pass through a #7 mesh screen and which are retained on a #12 screen having a particle size range of between about 1700 microns and about 2800 microns, and the remainder (c) about 30% of the extruded starch-based clumping litter pellets 42b composed of at least 5%, preferably at least 10%, and more preferably at least 15% extrusion-modified starch-based water-soluble binder clumping agent which have litter pellet particle sizes that pass through a #12 screen and are retained on a #35 screen having a particle size range of between about 500 microns and about 1700 microns. The calcium bentonite granules 46a have a bulk density of about 39 lbs/ft³, the calcium bentonite granules 46b have a bulk density of about 43 lbs/ft³, and the extruded starch-based absorbing pellets 42b have a bulk density of between 12 and 14 lbs/ft³. The litter 40′ of FIG. 6, Formula No. 4 has about 16.4% of its particles 42b, 46a, and/or 46b retained on a #7 mesh screen and having a particle size of between about 2800 microns and about 4750 microns, about 50.6% of its particles 42b, 46a, and/or 46b retained on a #12 screen and having a particle size of between about 1700 microns and about 2800 microns, about 24.5% of its particles 42b, 46a, and/or 46b retained on a #18 mesh screen, and having a particle size of between about 1000 microns and about 1700 microns, and about 8% of its particles 42b, 46a, and/or 46b retained on a #35 mesh screen, and having a particle size of between about 500 microns and about 1000 microns. This trial blend formulation produces a low tracking clumping litter 40′ in accordance with the present invention which preferably also is lightweight having a bulk density of between 20-40 lbs/ft³, preferably between 25-30 lbs/ft³, and more preferably about 28 lbs/ft³, which has a litter particle tracking effectiveness of no more than 100 particles per square inch, preferably no more than 90 particles per square inch, and preferably no more than about 89 particles per square inch, and which forms shed-resistant clumps when wetted with urine that have a clump retention rate of at least 98% and preferably at least 99% in one and preferably both the 10 minute and 30 minute clump retention tests.

If desired, a litter having a blend formulation similar to Trial Formula No. 4 can vary the weight percentages of the clumping and non-clumping constituents that make up the above multicomponent litter blend 40′. If desired, such a litter 40′ can be composed of between 0% and about 70%+5% calcium bentonite non-clumping litter particles 46a, between about 70%+5% and 0% calcium bentonite non-clumping litter particles 46b, and about 30%+5% starch-containing clumping particles 42b which preferably are starch-based extrudate clumping particles 42b which more preferably are starch-based extrudate clumping pellets 43. Such a litter 40′ can also be composed of between about 10% and about 50% calcium bentonite non-clumping litter particles 46a, between about 60% and about 10% calcium bentonite non-clumping litter particles 46b, and between about 30% and about 40% starch-containing clumping particles 42b which preferably are starch-based extrudate clumping particles 42b which more preferably are starch-based extrudate clumping pellets 43 In one litter blend formulation, the litter 40′ has no more than about 20% of the starch-containing clumping particles 42b which preferably are starch-based extrudate clumping pellets 42b which more preferably are extruded starch-based extrudate clumping pellets 43 with the remainder composed of non-clumping pellets 46a and/or 46b. One of the non-clumping particles 46a or 46b have varying particle sizes falling in a first non-clumping particle size range of between about 1400 microns and about 3000 microns, preferably between about 1500 microns and about 2900 microns, and more preferably between about 1700 microns and about 2800 microns, and the other one of the non-clumping particles 46b or 46a can have varying particle sizes falling in a second non-clumping particle size range of between about 2500 microns and about 5500 microns, preferably between about 2600 microns and about 5000 microns, and more preferably between about 2800 microns and about 4750 microns. If desired, the non-clumping particles 46a, 46b can collectively make up a clumping particle size range with varying particle sizes ranging between about 1400 microns and about 5500 microns, preferably between about 1500 microns and about 5000 microns, and more preferably between about 1700 microns and about 4750 microns. The clumping particles 42b have varying particle sizes falling between 200 microns and 2000 microns, preferably between about 250 microns and about 1800 microns, and more preferably between about 500 microns and about 1700 microns. If desired, the clumping particles 42b can be formulated or configured to have a clumping particle size range with varying particle sizes ranging between about 250 microns and about 2000 microns, preferably between about 500 microns and about 1700 microns. The respective particle size distributions and litter bulk density can be similar or substantially the same as disclosed in the preceding paragraph for Trial Formula No. 4. The litter particle tracking effectiveness and clump retention rates preferably are also similar or substantially the same as disclosed in the preceding paragraph for Trial Formula No. 4.

Formula No. 5 is a blend formulation composed of (a) about 30% by weight of non-clumping calcium bentonite granules 46a having particle sizes which pass through a #4 mesh screen and which are retained on a #6 screen having a particle size range of between about 3350 microns and about 4750 microns, (b) about 40% non-clumping calcium bentonite granules 46b whose particles pass through a #7 mesh screen and which are retained on a #12 screen having a particle size range of between about 1700 microns and about 2800 microns, (c) about 10% clumping sodium bentonite granules 42a having particle sizes which pass through a #12 screen and are retained on a #35 screen having a particle size range of between about 500 microns and about 1700 microns, and (d) about 20% of the extruded starch-based clumping litter pellets 42b composed of at least 5%, preferably at least 10%, and more preferably at least 15% extrusion-modified starch-based water-soluble binder clumping agent having particle sizes which pass through a #12 screen and are retained on a #35 screen having a particle size range of between about 500 microns and about 1700 microns. The calcium bentonite granules 46a have a bulk density of about 40 lbs/ft³, the calcium bentonite granules 46b have a bulk density of about 43 lbs/ft³, the sodium bentonite granules 42a have a bulk density of about 60 lbs/ft³, and the extruded starch-based absorbing pellets 42b have a bulk density of between 12 and 14 lbs/ft³. The multicomponent litter 40′ of Formula No. 5 has about 31% of its litter particles 42a, 42b, 46a and/or 46b retained on a #7 mesh screen and having particle sizes of between about 2800 microns and about 4750 microns, about 34.2% of its particles 42a, 42b, 46a and/or 46b retained on a #12 screen and having particle sizes of between about 1700 microns and about 2800 microns, about 25.5% of its particles 42a, 42b, 46a and/or 46b retained on a #18 mesh screen, and having particle sizes of between about 1000 microns and about 1700 microns, and about 9.3% of its particles 42a, 42b, 46a and/or 46b retained on a #35 mesh screen, and having particle sizes of between about 500 microns and about 1000 microns. The litter 40′ of this trial blend formulation is lightweight, having a bulk density of between 25-45 lbs/ft³, more preferably between 30-40 lbs/ft³, and preferably about 35.4 lbs/ft³, has a litter particle tracking effectiveness of no more than 75 particles per square inch, preferably no more than 60 particles per square inch, and preferably no more than about 51 particles per square inch, and forms shed-resistant clumps when wetted with urine that have a clump retention rate of at least 73% in the 10 minute drop test and of at least 97% in the 30 minute drop test.

If desired, a litter having a blend formulation similar to Trial Formula No. 5 can vary the weight percentages of the clumping and non-clumping constituents that make up the above multicomponent litter blend 40′. If desired, such a litter 40′ can be composed of between 0% and about 70% calcium bentonite non-clumping litter particles 46a, between about 70% and 0% calcium bentonite non-clumping litter particles 46b, between about 5% and about 15% sodium bentonite clumping litter particles 42a, and between about 25% and about 15% starch-containing clumping particles 42b which preferably are starch-based extrudate clumping particles 42b which more preferably are starch-based extrudate clumping pellets 43. Such a litter 40′ can also be composed of between about 25% and about 50% calcium bentonite non-clumping litter particles 46a, between about 55% and about 20% calcium bentonite non-clumping litter particles 46b, between about 5% and about 15% sodium bentonite clumping litter particles 42a, and between about 25% and about 15% starch-containing clumping particles 42b which preferably are starch-based extrudate clumping particles 42b which more preferably are starch-based extrudate clumping pellets 43. One of the non-clumping particles 46a or 46b have varying particle sizes falling in a first non-clumping particle size range of between about 1400 microns and about 3000 microns, preferably between about 1500 microns and about 2900 microns, and more preferably between about 1700 microns and about 2800 microns, and the other one of the non-clumping particles 46b or 46a can have varying particle sizes falling in a second non-clumping particle size range of between about 3000 microns and about 5500 microns, preferably between about 3100 microns and about 5000 microns, and more preferably between about 3350 microns and about 4750 microns. If desired, the non-clumping particles 46a, 46b can collectively make up a clumping particle size range with varying particle sizes ranging between about 1400 microns and about 5500 microns, preferably between about 1500 microns and about 5000 microns, and more preferably between about 1700 microns and about 4750 microns. The clumping particles 42a and/or 42b can respectively have varying particle sizes falling between about 200 microns and about 2000 microns, preferably between about 250 microns and about 1900 microns and more preferably between about 500 microns and about 1700 microns. If desired, the clumping particles 42a, 42b can collectively make up a clumping particle size range with varying particle sizes or corresponding clumping particle size ranges collectively ranging between about 250 microns and about 2000 microns, preferably between 500 microns and about 1700 microns. The respective particle size distributions and litter bulk density can be similar or substantially the same as disclosed in the preceding paragraph for Trial Formula No. 5. The litter particle tracking effectiveness and clump retention rates preferably are also similar or substantially the same as disclosed in the preceding paragraph for Trial Formula No. 5.

Finally, Formula No. 6 is a blend formulation composed of (a) about 70% by weight of non-clumping calcium bentonite granules whose particles 46b pass through a #7 mesh screen and which are retained on a #12 screen having a particle size range of between about 1700 microns and about 2800 microns, (b) about 10% clumping sodium bentonite granules whose particles 42a pass through a #12 screen and are retained on a #35 screen having a particle size range of between about 500 microns and about 1700 microns, and (c) about 20% of the extruded starch-based clumping litter pellets 42b composed of at least 5%, preferably at least 10%, and more preferably at least 15% extrusion-modified starch-based water-soluble binder clumping agent whose particles 42b pass through a #12 screen and are retained on a #35 screen having a particle size range of between about 500 microns and about 1700 microns. The calcium bentonite granules 46b have a bulk density of about 43 lbs/ft³, the sodium bentonite granules 42a have a bulk density of about 60 lbs/ft³, and the extruded starch-based absorbing pellets 42b have a bulk density of between 12 and 14 lbs/ft³. The litter 40′ of Formula No. 6 has about 0.3% of its particles 42a, 42b and/or 46b retained on a #7 mesh screen and having particle sizes between about 2800 microns and about 4750 microns, about 61.8% of its particles 42a, 42b and/or 46b retained on a #12 screen and having particle sizes between about 1700 microns and about 2800 microns, about 27.7% of its particles 42a, 42b and/or 46b retained on a #18 mesh screen and having particle sizes between about 1000 microns and about 1700 microns, and about 10.4% of its particles 42a, 42b and/or 46b retained on a #35 mesh screen and having particle sizes between about 500 microns and about 1000 microns. The litter 40′ of this blend formulation preferably also is lightweight, having a bulk density of between 25-45 lbs/ft³, preferably between 30-40 lbs/ft³, and more preferably about 33.6 lbs/ft³, has a litter particle tracking effectiveness of no more than 75 particles per square inch, preferably no more than 60 particles per square inch, and more preferably no more than about 51 particles per square inch, and forms shed-resistant clumps when wetted with urine that have a clump retention rate of at least 93% in the 10 minute test and at least 97%, preferably at least 98% in the 30 minute test.

If desired, a litter having a blend formulation similar to Trial Formula No. 6 can vary the weight percentages of the clumping and non-clumping constituents that make up the above multicomponent litter blend 40′. If desired, such a litter 40′ can be composed of about 70%+5% calcium bentonite non-clumping litter particles 46a, about 10%+5% of sodium bentonite clumping particles 42a, and about 20%+5% of which are starch-containing clumping particles 42b which preferably starch-based extrudate clumping particles 42b which more preferably are extruded clumping pellets 43 composed of starch-based extrudate containing at least 5%, preferably at least 10% and more preferably at least 15% cold water soluble binder clumping agent by starch-based extrudate weight. Such a litter 40′ can be composed of about between about 60% and about 80% calcium bentonite non-clumping litter particles 46a, about 10% sodium bentonite clumping particles 42a, and between about 10% and about 30% of starch-containing clumping particles 42b which preferably are starch-based extrudate clumping particles 42b which more preferably are extruded starch-based extrudate clumping pellets 43. The non-clumping particles 46a have varying particle sizes falling in a non-clumping particle size range of between about 1400 microns and about 3500 microns, preferably between about 1500 microns and about 3000 microns, and more preferably between about 1700 microns and about 2800 microns. The clumping particles 42b have varying particle sizes falling between 200 microns and 2000 microns, preferably between about 250 microns and about 1800 microns, and more preferably between about 500 microns and about 1700 microns. If desired, the clumping particles 42b can be formulated or configured to have a clumping particle size range with varying particle sizes ranging between about 250 microns and about 2000 microns. The respective particle size distributions and litter bulk density can be similar or substantially the same as disclosed in the preceding paragraph for Trial Formula No. 6. The litter particle tracking effectiveness and clump retention rates preferably are also similar or substantially the same as disclosed in the preceding paragraph for Trial Formula No. 6.

It should be noted that where the litter 40 or 40′ is a multicomponent litter 40′ that contains (a) at least a plurality of pairs of, i.e., at least three, clumping particles 42a composed of one type of clumping material 44a that is a swelling clay, such as preferably sodium bentonite, and (b) at least a plurality of pairs of, i.e., at least three, clumping particles 42b composed of another type of clumping material 44b that is a starch-containing clumping material that preferably is a starch-based extrudate containing clumping material 44b containing at least 5%, preferably at least 10%, more preferably at least 15% of a cold water soluble binder clumping agent, the presence of the starch-containing clumping material particles 42b that preferably are starch-based extrudate clumping material containing particles 42b forms clumps with the swelling clay clumping particles 42a, preferably sodium bentonite clumping particles 42a, which do not crack as the clump dries thereby advantageously producing a shedding-resistant clump having a clump retention rate of at least 97%, preferably at least 98%, and more preferably at least 99% in either and preferably both the 10 and 30 minute clump tests. Such a litter blend formulation where at least one clumping component is composed of a starch-containing clumping material that preferably is a starch-based extrudate clumping material containing at least 5%, preferably at least 10%, more preferably at least 15% of a cold-water soluble binder clumping agent advantageously significantly prevents and preferably substantially completely prevents shedding of spoiled litter particles from a clump formed using such a multicomponent litter 40′ of the invention as the clump is being scooped out of the litter box 50.

As previously noted, where the clumping particles 42b are starch-containing clumping material clumping particles 42b that are starch-based extrudate clumping material clumping particles 42b, the starch-based extrudate clumping material clumping particles 42b are at least partially composed of starch-based extrudate containing at least 5%, preferably at least 10%, more preferably at least 15% of a cold-water soluble binder clumping agent. As also previously noted, where the clumping particles 42b are starch-containing clumping material clumping particles 42b that are starch-based extrudate clumping material clumping particles 42b, the starch-based extrudate clumping material clumping particles 42b can be extruded sorbent pellets 43 composed substantially completely of the starch-based extrudate and/or clumping particles 42b composed of inner substrate particles substantially completely encased with an outer coating or layer of starch-based extrudate clumping material 44b.

From the aforementioned, including the data from the above trial blend formulations, a preferred low tracking clumping litter 40 or 40′ formulated in accordance with the present invention is composed of between 10% and 45% of the clumping particles 42 or 42a and 42b and of between 55% and 90% of the non-clumping particles 46 or 46a and 46b by weight of the litter 40 or 40′. In a preferred formulation, the litter 40 or 40′ is composed of between 15% and 40% by litter weight of the clumping particles 42 or 42a and 42b and between 60% and 85% by litter weight of the non-clumping litter 46 or 46a and 46b. The litter 40 or 40′ more preferably is composed of about 30%±5% of the clumping particles 42 or 42a and 42b and about 70%±5% of the non-clumping particles 46 or 46a and 46b. Such a litter 40 or 40′ formulated in accordance with these clumping and non-clumping litter particle weight percent ranges advantageously helps produce a lightweight low tracking clumping litter 40 or 40′ in accordance with the present invention having a desirably low bulk density of between 28 lbs/ft³ and 40 lbs/ft³ and preferably between about 32 lbs/ft³ and about 38 lbs/ft³.

A preferred litter 40 or 40′ in accordance with the present invention can be formulated with a blend of clumping particles 42 or 42a and/or 42b having a clumping particle size range of between 200 microns and 2000 microns and non-clumping particles 46 or 46a and/or 46b having a non-clumping particle size range of between 1400 microns and 5500 microns which can overlap along a particle size range of between 1400 microns and 2000 microns. Another preferred litter 40 or 40′ is formulated with a blend of clumping particles 42 or 42a and/or 42b having a clumping particle size range of between 250 microns and 1900 microns and non-clumping particles 46 or 46a and/or 46b having a non-clumping particle size range of between 1500 microns and 5000 microns which can overlap along a particle size range of between about 1500 microns and about 1900 microns. Where the litter 40 or 40′ is formulated with a region of clumping particle and non-clumping particle overlap, preferably at least 75%, more preferably at least about 85%, of the clumping particles 42 or 42a and 42b have particle sizes smaller than all the non-clumping particles 46 or 46a and 46b. Preferably, no more than 25%, preferably no more than about 15%, of the clumping particles 42 or 42a and 42b have particles with particle sizes larger than the smallest sized non-clumping particles 46 or 46a and 46b. In such an overlapping particle range formulation, no more than about 25%, preferably no more than about 20%, of the particles 42, 46 or 42a, 42b, 46a, 46b have particle sizes which overlap such that at least about 75%, preferably at least about 80% of the particles 42, 46 or 42a, 42b, 46a, 46b have particle sizes which do not overlap. Where the litter 40 or 40′ is formulated with such a region of overlap falling within the above percentages, it ensures there are enough clumping particles 42 or 42a and 42b sufficiently smaller than the non-clumping clumping particles 46 or 46a and 46b to relatively uniformly distribute the smaller clumping particles 42 or 42a and 42b into voids 45 in between and below larger non-clumping particles 46 or 46a and 46b to impart to the litter 40 or 40′ a desirably low litter particle tracking effectiveness and form clumps on top 52 of the litter 40 or 40′

A further preferred litter 40 or 40′ is formulated with a blend of clumping particles 42 or 42a and/or 42b having a clumping particle size range of between about 500 microns and about 1700 microns and non-clumping particles 46 or 46a and/or 46b having a non-clumping particle size range of between about 1700 microns and about 4750 microns which only overlap at or along the largest particle size(s) of the clumping particles 42 or 42a and 42b and the smallest particle size(s) of the non-clumping particles 46 or 46a and 46b. In still yet another litter formulation, the clumping particles 42 or 42a and/or 42b have a clumping particle size range ranging from no smaller than 500 microns to less than 1700 microns and the non-clumping particles 46 or 46a and/or 46b have a non-clumping particle size range ranging from greater than 1700 microns to no larger than 4750 microns. In such preferred substantially non-overlapping or non-overlapping litter formulations, substantially all of the clumping litter particles 42 or 42a and 42b have particle sizes smaller than the non-clumping particles 46 or 46a and 46b of the litter 40 or 40′ thereby ensuring that the smaller clumping particles 42 or 42a and 42b are relatively uniformly distributed into voids 45 in between and below larger non-clumping particles 46 or 46a and 46b impart the litter 40 or 40′ with a desirably low litter particle tracking effectiveness which form clumps on top 52 of the litter 40 or 40′ during litter use by an animal that preferably is a cat.

Where the litter 40 or 40′ is formulated with a region of clumping particle and non-clumping particle overlap, preferably at least about 75% of the clumping particles 42 or 42a and 42b have particle sizes smaller than all the non-clumping particles 46 or 46a and 46b. Preferably, no more than about 25% of the clumping particles 42 or 42a and 42b have particles with particle sizes larger than the smallest sized non-clumping particles 46 or 46a and 46b. In such an overlapping particle range formulation, no more than about 25% of the particles 42, 46 or 42a, 42b, 46a, 46b have particle sizes which overlap such that at least about 75% of the particles 42, 46 or 42a, 42b, 46a, 46b have particle sizes which do not overlap.

The litter 40 or 40′ is formulated such that the clumping particles 42 or 42a and 42b, which are stickier than the non-clumping particles 46, are sufficiently smaller than the non-clumping particles 46 or 46a and 46b to configure the litter 40 or 40′ so that when the litter is disposed in a litter box 50, substantially all of the smaller clumping particles 42 or 42a and 42b are distributed below the larger non-clumping particles 46 or 46a and 46b that substantially form the top surface 52 of the litter 40 or 40′ advantageously reducing tracking by minimizing the number of smaller stickier clumping particles 42 on the surface 52 which can come into contact with the paws of a cat walking on the surface 52 of the litter 40 or 40′ during litter use by the cat. As discussed in more detail below, the larger sized non-clumping particles 46 or 46a and 46b are configured to have particle sizes sufficiently large enough to prevent them from being picked up by a paw of a cat walking on the surface 52 of the litter 40 or 40′. Because these particles 46 or 46a and 46b are larger, they are also heavier thereby also making them less likely to stick to the fur of a cat using the litter 40 or 40′. And because these particles 46 or 46a and 46b are not clumping particles 42 or 42a and 42b, which are made of stickier clumping material 44 or 44a and 44b, tracking of particles 42, 46 or 42a, 42b, 46a, 46b of litter 40 or 40′ from litter box 50 is reduced because these larger, heavier particles 46 or 46a and 46b are also not as sticky further making them less likely to stick to the paws or fur of a cat using the litter 40 or 40′.

A low tracking litter 40 or 40′ of the present invention formulated with smaller clumping particles 42 or 42a and 42b that have particle sizes and preferably also clumping particle size range(s) smaller than the particle sizes and non-clumping particle size range(s) of the non-clumping particles 46 or 46a and 46b configures the litter 40 or 40′ so that the smaller clumping particles 42 or 42a and 42b are distributed below and in between the non-clumping particles 46 or 46a and 46b that form the litter's surface 52 as well as non-clumping particles 46 or 46a and 46b below the surface 52 when pouring the litter 40 or 40′ from its retail container or store-bought package into a litter box 50. In a preferred embodiment, this also occurs when blending particles 42, 44 to form litter 40 or when blending particles 42a, 42b, 46a and/or 46b to form multicomponent litter 40′. Such a litter formulation produces low tracking clumping litters 40 or 40′ in accordance with the present invention configured to advantageously distribute their respective litter particles 42, 46 of litter 40 or litter particles 42a, 42b, 46a, 46b of litter 40′ in this manner when poured from its container or package into a litter box 50, even where stratification of some of the particles 42, 44 of litter 40 or particles 42a, 42b, 46a, 46b of litter 40 in the container or package has occurred prior to being poured from the container or package into the box 50.

This not only advantageously minimizes tracking by minimizing the number of smaller clumping particles 42 of litter 40 or clumping particles 42a and 42b of litter 40′ disposed on and along the surface 52 of the litter 40 or 40′, but it also results in smaller clumping particles 42 or 42a and 42b flowing in between larger non-clumping particles 46 or 46a and 46b disposed along the litter's surface 52 into voids 45 between and below adjacent larger non-clumping particles 46 or 46a and 46b disposed below the litter's surface 52 as the litter 40 or 40′ is being poured from its container or package into the litter box 50. Since these voids 45 would ordinarily form channels in the litter 40 or 40′ through which urine from an animal, preferably a cat, could undesirably flow downwardly towards the bottom 54 of the litter box 50, packing these voids 45 with such smaller clumping particles 42 or 42a and 42b advantageously blocks downward urine flow through these voids 45. This is because the particles 42 or 42a and 42b in the voids 45 closest to the surface 52 and further below the surface 52 become quickly wetted by and absorb urine rapidly swelling in size to plug these voids 45 near and further below the surface 52 thereby trapping the urine at or near the litter's surface 52 advantageously ensuring the clump of at least a plurality of pairs of particles 42, 46 or 42a, 42b, 46a, 46b of the litter 40 or 40′ forms on top 52 where it can be easily scooped out of the litter 40 or 40′. Trapping the urine at or near the litter's surface 52 also rapidly activates the clumping material 44 of the wetted clumping particles 42 or clumping material 44a and/44b of the wetted clumping particles 42a and 42b, such as by rapidly activating clumping agent in the clumping material 44 of the wetted clumping particles 42 or clumping agent in the clumping material 44a and/44b of the wetted clumping particles 42a and 42b quickly forming an expanding ball-like clump of wetted clumping particles 42 and wetted non-clumping particles 46 of litter 40 or wetted clumping particles 42a and/or 42b and wetted non-clumping particles 46a and 46b of the litter 40′ on or near the litter's surface 52 that can be easily scooped out.

Where the clumping particles 42 or 42a and/or 42b contain clumping material 44 or 44a and/or 44b that is water activated or contains a water-activated clumping agent, such as where one or both of the particles 42 or 42a and/or 42b of litter 40 or 40′ are partially, substantially completely or completely composed starch-based extrudate clumping material containing extrusion-modified starch cold water soluble binder clumping agent, wetting of the particles 42 or 42a and/or 42b with urine or water causes at least some of the clumping material 44 or 44a and/or 44b of the wetted clumping particles 42 or 42a and/or 42b, preferably at least some of the clumping agent thereof, to become water activated and flow, such as in the form of a viscous liquid, therefrom. The viscous flow of the activated clumping material 44 or 44a and/or 44b, such as or including activated clumping agent therefrom, also facilitates plugging of these voids 45 in the litter 40 or 40′ helping to prevent further downward urine flow. Because this viscous flowable clumping material 44 or 44a and/or 44b from these particles 42a and/or 42b and/or viscous flowable clumping agent therefrom is pliable or formable to nearly any shape, it readily flows in between clumping particles 42 or 42a and/or 42b and non-clumping particles 46 or 46a and/or 46b alike filling and plugging the voids 45. As it flows by being wetted by and absorbing the urine and being carried by the urine away from the wetted clumping particles 42 or 42a and/or 42b from which the viscous flowing clumping material and/or clumping agent originated, it preferably also swells thereby further helping to plug voids 45 in the litter 40 or 40′ downstream of the urine, further helping to trap urine on top 52, and further helping to ensure that clumps form on top 52 of the litter 40 or 40′.

Where the clumping material 44 or 44a and/or 44b of at least one of the clumping particles 42 or 42a and/or 42b of the litter 40 or 40′ is partially, substantially completely or completely composed of a starch-based or starch-containing clumping material, such as preferably starch-based extrudate containing at least 5%, preferably 10%, more preferably 15% extrusion-modified starch cold water soluble binder clumping agent, wetting of such clumping particles 42 or 42a and/or 42b at least partially solubilizes some of the starch-based clumping material 44 or 44a and/or 44b activating at least some it or its extrusion-modified starch cold water soluble binder clumping agent. At least some of the wetted clumping material 44 or 44a and/or 44b and/or at least some of its extrusion-modified starch cold water soluble binder clumping agent in particles 42 or 42a or 42b flows from the wetted particles 42 or 42a and/or 42b in between adjacent clumping particles 42 or 42a and/or 42b and/or adjacent non-clumping particles 46 or 46a and/or 46b alike flowing into the voids 45 in the litter 40 or 40′ plugging the voids 45 substantially simultaneously causing these adjacent wetted particles 42 and 46 or 42a, 42b, 46a and/or 46b to clump together near the surface 52 of the litter 40 or 40′.

Where the clumping material 44 or 44a and/or 44b of at least one of the clumping particles 42 or 42a and/or 42b is partially, substantially completely or completely composed of starch-based extrudate containing at least 5%, preferably at least 10%, more preferably at least 15% extrusion-modified starch cold water soluble binder clumping agent, wetting such starch-based extrudate clumping material containing pellets 42 or 42a and/or 42b with urine at least partially solubilizes at least some of the cold water soluble binder clumping agent in the starch-based extrudate clumping material containing clumping particles 42 or 42a and/or 42b turning it into a flowable adhesive that flows or is released therefrom. This flowable adhesive flows in between adjacent clumping particles 42 or 42a and/or 42b and non-clumping particles 46 or 46a and/or 46b, including in the voids 45 therebetween in the litter 40 or 40′, contacting these adjacent particles 42 and 46 or 42a, 42b, 46a and/or 46b, relatively rapidly increasing in viscosity over time gelling and preferably becoming a gel that is an adhesive gel that binds these adjacent particles 42 and 46 or 42a, 42b, 46a and/or 46b together into a clump on or near the surface 52 of the litter 40 or 40′.

Globules of at least partially solubilized clumping material 44 or 44a and/or 44b and/or at least partially solubilized clumping agent thereof or therefrom, and which can be partially or completely composed of at least some flowable adhesive, can also become cleaved off from the starch-based extrudate clumping material containing particles 42 or 42a and/or 42b and which can also be pliable, deformable or otherwise formable into nearly any shape facilitates being carried by flowing urine or water into these voids 45 in the litter 40 or 40′ near and/or below the litter's surface 52 helping plug them up trapping the urine at or near the top 52 of the litter 40 or 40′ also bonding adjacent particles 42 and 46 or 42a, 42b, 46a and/or 46b in contact therewith together into a clump on or near the surface 52 of the litter 40 or 40′. As these globules flow with the, they preferably act as plugs that plug downstream voids 45 in the litter 40 or 40′ obstructing further downward urine flow trapping the urine adjacent to and just below the surface 52 of the litter 40 or 40′. These globules also swell which further helps plug voids 45 in the litter 40′ further helping obstruct downward urine flow all of which facilitates forming clumps of wetted litter particles 42 and 46 or 42a, 42b, 46b and/or 46b in the litter box 50.

In at least one preferred embodiment, the litter 40 or 40′ is formulated so that (a) the particle size of the largest size clumping litter particles 42 or 42a and/or 42b is at least 40%, preferably at least 45%, and more preferably at least about 50% smaller than the particle size of the smallest size non-clumping litter particles 46 or 46a and/or 46b, and (b) the size of the smallest size clumping particles 42 or 42a and/or 42b are between about 4% and about 10% of the size of the smallest size non-clumping particles 46 or 46a and/or 46b configuring the litter 40 or 40′ to be a low tracking litter having a tracking effectiveness of no greater than 100 particles per square inch, preferably no greater than 80 particles per square inch, and more preferably no greater than about 60 particles per square inch and preferably also forms clumps with reduced shedding that have a retention rate of at least 90%, preferably at least 95%, and more preferably at least 97% at 3 minutes and/or 10 minutes. Such low shedding clumps can and preferably also have a clump compression strength of at least 50 pounds per square inch, preferably at least 100 pounds per square inch, and even more preferably at least 200 pounds per square inch.

In at least one other preferred embodiment, the litter 40 or 40′ is formulated so that the particle size of the largest sized clumping litter particles 42 of litter 40 or largest sized clumping litter particles 42a and 42b of litter 40′ is at least 40%, preferably at least 45%, and more preferably at least about 50% of the particle size of the smallest sized non-clumping litter particles 46 of litter 40 or smallest sized non-clumping particles 46a and 46b of litter 40′ configuring the litter 40 or 40′ so it has a desirably low tracking effectiveness of no greater than 100 particles per square inch, preferably no greater than 90 particles per square inch, and more preferably no greater than about 60 particles per square inch. In one such preferred embodiment, the litter 40 or 40′ is formulated such that the size of the largest sized clumping litter particles 42 or largest sized clumping particles 42a and 42b is between about 40% and about 60% of the size of the smallest size non-clumping litter particles 46 or smallest size non-clumping particles 46a and 46b thereby configuring the litter 40 or 40′ to have a desirably low tracking effectiveness of no greater than 100 particles per square inch, preferably no greater than 80 particles per square inch, and more preferably no greater than about 60 particles per square inch. Such litter formulations preferably also form litter clumps during use of the litter 40 or 40′ by a cat configured to reduce shedding during scooping by the clumps having (a) a clump retention rate of at least 90%, preferably at least 95%, and more preferably at least 97% at 3 minutes and/or 10 minutes and/or (b) a clump compression strength of at least 50 pounds per square inch, preferably at least 100 pounds per square inch, and more preferably at least 200 pounds per square inch.

It has been surprisingly found where a low tracking clumping litter 40 or 40′ of the present invention formulated of a litter blend of (a) clumping particles 42 or 42a and/or 42b having a clumping particle size range, such as where the clumping particles 42 or 42a and/or 42b range in size between 200 microns and 2000 microns, such as preferably between 250 microns and 1800 microns, such as more preferably between about 500 microns and about 1700 microns, and (b) non-clumping particles 46 or 46a and/or 46b having a non-clumping particle size range, such as where the non-clumping particles 46 or 46a and/or 46b range in size between 1400 microns and 5500 microns, such as preferably between 1500 microns and 5000 microns, such as more preferably between about 1700 microns and about 4750 microns, the proportion of the weight percent of the clumping particles of the litter 40 or 40′ relative to the weight percent of the non-clumping particles of the litter 40 or 40′ is between 0.10 and 0.82, preferably between 0.15 and 0.70, and more preferably between about 0.3 and about 0.55, as this results in the low tracking litter 40 or 40′ having a desirably low litter particle tracking effectiveness as discussed below in the next paragraph, and produces low-shedding clumps that form on top of the litter 40 or 40′ having a desirably high clump retention rate as also discussed below in the next paragraph. This is because the non-clumping particles 46 or 46a and/or 46b are sized large enough so as to not be easily picked up by cat's paws, the clumping particles 42 or 42a and/or 42b are sized small enough to automatically become distributed between and below non-clumping particles 46 or 46a and/or 46b disposed on the litter's surface 52 producing a top litter surface 52 composed substantially completely of larger non-clumping particles that significantly reduces tracking and packing clumping particles into voids 45 between and underneath adjacent non-clumping particles 46 or 46a and/or 46b ensuring clumps are formed on top 52. This also produces a low tracking litter 40 or 40′ which reduces tracking by minimizing the weight percent of stickier clumping particles 42 or 42a and/or 42b used and which are disposed on or along the litter's surface 52 while still having enough of the clumping particles 42 or 42a and/or 42b in the litter 40 or 40′ to ensure the clumps are not only formed on top 52 but which are also of low-shedding construction. In a preferred embodiment, it also has been surprisingly found that such a low tracking clumping litter 40 or 40′ of the present invention formulated of a litter blend of clumping particles 42 or 42a and/or 42b having a clumping particle size range where the clumping particles 42 or 42a and/or 42b range in size between 200 microns and 2000 microns, such as preferably between 250 microns and 1800 microns, such as more preferably between about 500 microns and about 1700 microns, and the non-clumping particles 46 or 46a and/or 46b having a non-clumping particle size range where the non-clumping particles 46 or 46a and/or 46b range in size between 1400 microns and 5500 microns, such as preferably between 1500 microns and 5000 microns, such as more preferably between about 1700 microns and about 4750 microns, where (a) at least 75% of the clumping particles in the litter 40 or 40′ have particle sizes smaller than the non-clumping particles of the litter 40 or 40′, preferably all or substantially all of the clumping particles have a particle size no greater than about the smallest sized particles of the non-clumping particles, and (b) the proportion of the weight percent of the clumping particles of the litter 40 or 40′ relative to the weight percent of the non-clumping particles of the litter 40 or 40′ is between 0.10 and 0.82, preferably between 0.15 and 0.70, and more preferably between 0.3 and 0.55, as this results in the low tracking litter 40 or 40′ having a desirably low litter particle tracking effectiveness and produces low-shedding clumps that form on top of the litter 40 or 40′.

A litter 40 or 40′ having such litter blend formulations possess a desirably low tracking effectiveness of no greater than 150 litter particles per square inch of the litter's top surface 52, preferably no greater than 100 particles per square inch, more preferably no greater than 80 particles per square inch and even more preferably no greater than about 60 particles per square inch. A litter 40 or 40′ having such a litter blend formulation also advantageously forms clumps on the litter's surface 52 that have good clump integrity that preferably are of low-shedding construction by having a clump retention rate of at least 95%, preferably at least 97% and more preferably at least 98%. Such a litter 40 or 40′ preferably also forms clumps which have a clump compressive strength of at least 50 pounds per square inch, preferably at least 100 pounds per square inch and more preferably at least 200 pounds per square inch.

A litter 40 or 40′ having such a litter blend formulation contains no more than 45%, preferably no more than 35% of the clumping particles 42 or 42a and/or 42b by litter weight advantageously minimizing the amount or number of smaller clumping particles 42 or 42a and/or 42b in the litter blend that can be tracked out of the litter box 50. The litter 40 or 40′ preferably contains at least 10%, preferably at least 15% of the clumping particles 42 or 42a and/or 42b by litter weight to ensure enough clumping particles 42 or 42a and/or 42b are present to not only adequately fill voids 45 between non-clumping particles 46 or 46a and/or 46b to form clumps on top 52 but also to form clumps of good integrity that preferably are low shedding by having a clump retention rate of at least 95%, preferably 97% and more preferably at least 98%. Such a litter 40 or 40′ contains at least 55%, preferably at least 65% and no more than 85%, preferably no more than 90% of the non-clumping particles 46 or 46a and/or 46b by litter weight to ensure the litter blend contains enough of the more difficult to track larger heavier non-clumping particles 46 or 46a and/or 46b resulting in the larger non-clumping particles 46 or 46a and/or 46b substantially completely forming the surface 52 of the litter 40 or 40′ minimizing tracking. Such a litter blend preferably results in at least 95%, preferably at least 98% and more preferably at least 99% of the litter particles that form the top surface 52 of the litter 40 or 40′ being formed of larger heavier non-clumping particles 46 or 46a and/or 46b. Litter blends that are a combination of these clumping particle weight percent ranges and smaller particles of clumping particles 42 or 42a and/or 42b and these non-clumping particle weight percent ranges and larger particles of non-clumping particles 46 or 46a and/or 46b ensure that the voids 65 formed between adjacent larger sized non-clumping particles 46 or 46a and/or 46b automatically become packed with smaller sized clumping particles 42 or 42a and/or 42b when the litter 40 or 40′ is poured into a litter box 50. This advantageously occurs even where prior segregation between smaller clumping particles 42 or 42a and/or 42b and larger non-clumping particles 46 or 46a and/or 46b of litter 40 or 40′ occurs in the litter package before the litter 40 or 40′ is poured into the litter box 50.

One preferred embodiment of such a litter blend in accordance with the present invention having such desirably low tracking and desirably low-shedding clumping can be and preferably is further characterized by the litter 40 or 40′ having a mean particle size ratio of the mean particle size of the non-clumping particles 46 divided by the mean particle size of the clumping particles 42 of litter 40 or the mean particle size(s) of non-clumping particles 46a and/or 46b divided by the mean particle size(s) of the clumping particles 42a and/or 42b ranging between 2.80 and 3.15, preferably between 2.85 and 3.05, and more preferably between about 2.88 and about 2.95. While preferred litter blends can have at least about 75% of the clumping particles 42 or 42a and/or 42b with particle sizes smaller than the non-clumping particles 46 or 46a and/or 46b, other preferred low tracking clumping blends formulated in accordance with the present invention have clumping particles with a clumping particle size distribution and/or clumping particle size range where the largest sized clumping particles 42 or 42a and/or 42b are no larger in size than the smallest sized non-clumping particles 46 or 46a and/or 46b of a non-clumping particle size distribution and/or non-clumping particle size range of the non-clumping particles 46 or 46a and/or 46b of the litter 40 or 40′.

It also has been unexpectedly discovered that litter blend formulations that have the largest sized clumping particles 42 or clumping particles 42a and/or 42b no larger than the smallest sized non-clumping particles 46 or non-clumping particles 46a and/or 46b and the ratio of the smallest sized non-clumping particles 46 or non-clumping particles 46a and/or 46b relative to the largest sized clumping particles 42 or clumping particles 42a and/or 42b falls within a predetermined range of ratios that are between about 1 and about 2.5, preferably between 1 and 2, it results in the litter 40 or 40′ being low tracking by having a litter particle tracking effectiveness of no greater than 150 particles per square inch, preferably no greater than 100 particles per square inch, more preferably no greater than 80 particles per square inch, and more preferably no greater than about 60 particles per square inch. A low tracking clumping litter 40 or 40′ configured with clumping and non-clumping particle blends having ratios of the smallest sized non-clumping particles 46, 46a and/or 46b relative to the largest sized clumping particles 42, 42a and/or 42b falling between about 1 and about 2.5, preferably between 1 and 2, also advantageously results in all of the clumping particles 42 or clumping particles 42a and/or 42b being sized small enough, and preferably sufficiently smaller than, and relative to the non-clumping particles 46 or non-clumping particles 46a and/or 46b to ensure that smaller sized clumping particles 42, 42a and/or 42b will be distributed between and underneath at least a plurality of pairs, i.e., at least three, of the larger sized non-clumping particles 46, 46a and/or 46b that are adjacent to other larger sized non-clumping particles 46, 46a and/or 46b to sufficiently pack them into the voids 45 between these at least plurality of pairs of adjacent non-clumping particles 46, 46a and/or 46b to form clumps on top 52.

Such blends or formulations of low tracking clumping litter 40 or 40′ of the present invention differs significantly in terms of the particle size ranges and percentages by weight of the respective components in comparison to prior art litter formulations. More specifically, the non-clumping particles 46a and/or 46b have larger particle sizes and size ranges with larger particle sizes at each particle size range boundary than the particle sizes and particle size ranges of prior art clumping litters. Ranges of particle sizes of the present litter 40 or 40′, the sizes of the clumping particles 42, 42a, and/or 42b and non-clumping particles 46, 46a, and/or 46b may vary so long as the clumping particles 42, 42a, and/or 42b are small enough relative to the sizes of the significantly larger non-clumping particles 46, 46a and/or 46b so that the smaller clumping particles 42, 42a and/or 42b are substantially completely disposed below the surface 52 of litter 40 or 40′ in a litter box 50 away from contact with a cat's paw treading on the litter's surface 52 during use of the litter 40 or 40′. Ranges of particle sizes of the present litter 40 or 40′, the sizes of the clumping particles 42, 42a, and/or 42b and non-clumping particles 46, 46a, and/or 46b may vary so long as the clumping particles 42, 42a, and/or 42b are small enough relative to the sizes of the non-clumping particles 46, 46a and/or 46b so that the smaller clumping particles 42, 42a and/or 42b form a matrix when wetted with urine that produces a clump that is strong, possesses good clump integrity, possess a high clump retention rate greater than 90%, preferably greater than 95% and more preferably greater than 97%. Such a low tracking clumping litter 40 or 40′ is formulated with clumping particles 42, 42a and/or 42b and non-clumping particles 46, 46a and/or 46b where the particle sizes, preferably the smallest and largest particles sizes, of the smaller clumping particles 42, 42a and 42b are smaller, preferably sufficiently smaller, than the particle sizes, preferably the smallest and largest particle sizes, of the larger non-clumping particle sizes 46, 46a, and 46b, so as to fall within one of the preferred particle size percentage relationships, particle size ratios or ratio ranges, and/or particle size range ratios or particle size range ratio ranges disclosed hereinabove which produce a low tracking clumping litter 40 or 40′ in accordance with the present invention which has a desirably low litter particle tracking effectiveness, and ensures clumps of the litter 40 or 40′ form on top 52 of the litter 40 or 40′ during use of the litter.

Such a low tracking clumping litter configuration results in the smaller clumping particles 42, 42a and/or 42b being small enough to be contained within the voids 45 between the much larger non-clumping particles 46, 46a and/or 46b thereby advantageously filling these voids 45, with the non-clumping particles 46, 46a and/or 46b being sufficiently large relative to the size of the much smaller clumping particles 42, 42a and/or 42b to allow clumping materials, including clumping agent(s) thereof, of urine wetted clumping particles 42, 42a and/or 42b to fill these voids 45 preventing the voids 45 from forming interconnected downwardly-extending channels in the litter 40 or 40′ thereby preventing urine from flowing downwardly through these voids 45. This prevents the non-clumping particles 46, 46a and/or 46b from interrupting the clumping particles 42, 42a and/or 42b from forming an interlocking matrix produced by the release of clumping agent, such as extrusion-modified starch cold water-soluble binder, in starch-based extrudate containing clumping material of one of the clumping particles 42, 42a and 42b, which encapsulates both the clumping and non-clumping particles 42 and/or 46 or 42a, 42b, 46a and/or 46b of the litter 40 or 40′ into a wet/damp ball like clump of the particles 42 and/or 46 or 42a, 42b, 46a and/or 46b. To facilitate this result, preferably no more than 10% by weight of the particles 42, 42a, and/or 42b, 46, 46a and/or 46b of the clumping and non-clumping materials 44 and 48 and/or 44a, 44b, 48a and/or 48b overlap in particle size. Most preferably, no more than 5% of the particles 42, 42a, 42b, 46, 46a and/or 46b of the clumping and non-clumping materials 44 and 48 and/or 44a, 44b, 48a and/or 48b overlap in particle size.

In one embodiment of a litter 40 or 40′ of the present invention, the particle sizes of all the non-clumping particles 46 or 46a and/or 46b are larger than the particle sizes of the clumping particles 42 or 42a and/or 42b. As a result of this configuration, clumping occurs where the smaller clumping particles 42 or 42a and/or 42b fill the large voids 45 between and around the non-clumping particles 46 or 46a and/or 46b. Because of the differences in particle size distribution of the non-clumping particles 46 or 46a and/or 46b relative to the clumping particles 42 or 42a and/or 42b, the clumping particles 42 or 42a and/or 42b are small enough to fit into the voids 45 formed between and around adjacent non-clumping particles 46 or 46a and/or 46b. When urine enters litterbox 50, this causes the clumping agent(s) of the clumping material 44, 44a and/or 44b of the clumping particles 42 or 42a and/or 42b to instantly swell and block the urine from traversing through the litter 40 or 40′ downwardly to the bottom of the litterbox 50. The clumping agent from the urine-wetted clumping particles 42 or 42a and/or 42b flows from these wetted particles 42 or 42a and/or 42b into the urine stream and plugs holes and voids in between and around adjacent non-clumping particles 46 or 46a and/or 46b in the litter 40 or 40′, blocking the urine stream from flowing downwardly trapping the urine at or near the surface 52 of the litter 40 or 40′ resulting in the formation of clumps on top of the litter 40 or 40′.

Turning to Table 1 of FIG. 5, the percentages by weight of the various clumping materials 44a and/or 44b of the clumping particles 42a and/or 42b, and non-clumping materials 48a and/or 48b of the non-clumping particles 46a and/or 46b contained in six formulations of low tracking litter product trials formulated in accordance with present invention are presented, with each containing approximately 70%±15% by weight in non-clumping particles 46 or 46a and/or 46b of a non-clumping material 48, such as calcium bentonite and/or ground walnut shell particles, or a blend of non-clumping particles 46a of calcium bentonite 48a and non-clumping particles 46b of walnut shell particles 48b, and approximately 30%±15% by weight in clumping particles 42 of a clumping material 44 such as sodium bentonite or a starch-based clumping material, preferably a starch-based extrudate containing at least 5%, preferably at least 10%, more preferably at least 15%, cold water soluble binder clumping agent, or a blend of clumping particles 42a of sodium bentonite 44a and clumping particles 42b that are extruded starch-based pellets 43 at least partially, substantially completely or completely composed of such starch-based extrudate containing at least 5%, preferably at least 10%, more preferably at least 15% extrusion-modified starch cold water soluble binder clumping agent, such as extruded pellets 43 of the Light Weight Natural Grass Litter.

In one or more preferred litter blends, the non-clumping particles 46 of litter 40 or at least one of the non-clumping particles 46a and/or 46b of litter 40′ can be at least partially made of paper or paper fibers, such as recycled and/or deinked paper fibers, formed into balls or granules. The balls or granules can be used as the non-clumping particles 46 of litter 40 or can be used at least one of the non-clumping particles 46a and/or 46b of litter 40′. In a preferred embodiment, the non-clumping litter particles 46 of litter 40 or non-clumping litter particles 46a and/or 46b of litter 40′ are urine and water absorbent paper balls or urine and water absorbent paper granules composed substantially completely of paper fiber that can be substantially completely composed of recycled and/or deinked paper fibers, such as post-consumer waste deinked and recycled paper fibers formed into the balls or granules. Where urine and water absorbent paper balls or urine and water absorbent paper granules are used as non-clumping litter particles, they absorb at least one times their weight in urine or water during litter use.

In certain preferred embodiments of low tracking clumping litter 40 or 40′ of the present invention, the non-clumping pellets 46 or 46a and/or 46b and/or their non-clumping material 48 or 48a and/or 48b makes up approximately 60-70% by weight of the low tracking litter mixture, blend or formulation. In one preferred embodiment of the present invention, non-clumping particles 46 or 46a of calcium bentonite 48 or 48a make up approximately 70-80% by weight of the low tracking litter mixture, blend or formulation, while in others the non-clumping particles 46a, 46b is respectively made up of approximately 30-40% by weight of calcium bentonite 48a and approximately 30-40% by weight of ground walnut shells 48b. In certain embodiments, the clumping particles 42a, 42b are made up of approximately 10-15% by weight of sodium bentonite 44a and approximately 10-15% by weight of extruded cereal grain, while in other embodiments the clumping material is approximately 5-15% by weight of sodium bentonite and approximately 15-25% by weight of a starch-based clumping material 44b that preferably is a starch-based extrudate containing at least 5%, preferably at least 10%, more preferably at least 15% extrusion-modified starch cold water soluble binder clumping agent.

In yet other embodiments, one or more of the clumping particles 42 or 42a and/or 42b can also include or be composed of a gum, such as guar gum, plated onto substrate particles, e.g., non-clumping and/or non-absorbent particles, such as in the manner discussed above, having a particle size or particle sizes sufficiently smaller than the non-clumping particles 46a and/or 46b used in the litter 40 or 40′ in accordance with one or more of the clumping/non-clumping particle size percentages, clumping/non-clumping particle size percentage ranges, clumping/non-clumping particle size range ratios and/or clumping/non-clumping particle size range ratio ranges that result in low tracking clumping formulations of litter 40 or 40′ of the present invention. Specific but exemplary particle size distributions of each of these clumping particles 42a and/or 42b and clumping material(s) 44a and/or 44b and these non-clumping particles 46a and/or 46b and non-clumping materials 48a and/or 48b of low tracking litter product Trial Formulation Nos. 1-6 are contained in Table 2 of FIG. 6. Because of the particle size distributions of the clumping particles 42a and/or 42b and non-clumping particles 46a and/or 46b of the respective Trial Formulation Nos. 1-6 of the present invention, a low tracking litter 40 or 40′ of the present invention is formulated to be configured to have approximately 70% or more of the surface area of the top surface 52 of the litter 40 or 40′ in a litter box 50 exposed to paws of a cat using the litter being composed of non-clumping particles 46a and/or 46b having particle sizes greater than 1700 microns that is too large to become adhered to the cat's paw and be tracked from the litter 40 or 40′ outside of the litterbox 50.

In this regard, in one or more such preferred litter blends, the clumping particles 42 of litter 40 or at least one of the clumping particles 42a and/or 42b of litter 40′ are composed of cellulose containing matter, such as cellulosic fibrous material, e.g., cellulose fibers, wood fibers, paper fibers, or plant fibers, treated with a gum, such as preferably guar gum, or another type of gum as a clumping material that is or contains a clumping agent. In a preferred embodiment, the clumping particles 42 of litter 40 or at least one of the clumping particles 42a and/or 42b of litter 40′ are treated with such a gum, preferably guar gum, by applying the gum to cellulose containing matter, such as cellulosic fibrous material, e.g., cellulose fibers, wood fibers, paper fibers, or plant fibers, in an amount sufficient for the clumping particles 42 or 42a and/or 42b to form a clump when wetted with urine or water. The clumping particles 42 of litter 40 or at least one of the clumping particles 42a and/or 42b of litter 40′ are treated with such a gum, preferably guar gum, by coating the cellulose containing matter, such as cellulosic fibrous material, e.g., cellulose fibers, wood fibers, paper fibers, or plant fibers, with the gum, preferably guar gum, in an amount sufficient for the clumping particles 42 or 42a and/or 42b to form a clump when wetted with urine or water. The clumping particles 42 or 42a and/or 42b are each at least partially coated and preferably substantially completely coated with a gum, preferably guar gum. When coated with a gum, such as preferably guar gum, each clumping particle contains at least 3% by clumping particle weight of the gum. In at least one preferred clumping particle embodiment, clumping particles 42 of litter 40 or at least one of the clumping particles 42a and/or 42b are composed of paper balls or paper granules at least partially coated with a gum, such as preferably guar gum, in an amount, preferably at least 3% by litter particle weight, sufficient for the resultant clumping particles to form clumps when wetted with urine or water. The paper balls or paper granules can be at least partially and preferably substantially completely made of deinked and/or recycled paper fibers, e.g., post-consumer waste deinked and recycled paper fibers, coated or otherwise treated with a gum, such as preferably a guar gum, in an amount of at least 3% sufficient for the resultant clumping particles to form clumps when wetted with urine or water.

In a preferred embodiment, a multicomponent litter 40′ of the present invention has (a) a plurality of different clumping particles 42a and/or 42b of at least one clumping material and which can be composed of different clumping materials 44a and/or 44b, and (b) a plurality of different non-clumping particles 46a and/or 46b of at least one clumping material and which can be composed of different clumping materials 48a and/or 48b. The clumping particles 42a and/or 42b each have at least a plurality of pairs of, i.e., at least three, differently sized clumping litter particles which can be and preferably encompass respective first and second clumping particle size distributions. The non-clumping particles 46a and/or 46b each have at least a plurality of pairs of, i.e., at least three, differently sized non-clumping litter particles which can be and preferably encompass respective first and second non-clumping particle size distributions.

The clumping particles 42a and/or 42b of the multicomponent litter 40′ collectively make up no more than 45%, preferably no more than 40%, more preferably no more than about 30%±5% by litter weight and the non-clumping particles 46a and/or 46b collectively make up no less than 55%, preferably no less than 60%, and more preferably no more than about 70%±5% by litter weight. In one embodiment, the clumping particles 42a and/or 42b make up no more than about 20%±5% of the litter 40′ and the remainder, e.g., up to about 80%±5%, can be made up of non-clumping particles 46a and/or 46b.

The clumping particles 42a and/or 42b collectively have particle sizes ranging between 200 microns and 2000 microns, preferably between 250 microns and 1900 microns, and more preferably between about 500 microns and about 1700 microns, and the non-clumping particles 46a and/or 46b collectively have particle sizes ranging between 1400 microns and 5500 microns, preferably between 1500 microns and 5000 microns, and more preferably between about 1700 microns and about 4750 microns. In one embodiment, clumping particles 42a have varying particle sizes that make up at least one part of one of the aforementioned clumping particle size ranges and clumping particles 42b have varying particle sizes that make up at least another part of the one of the aforementioned clumping particle size ranges. The clumping particle size range of clumping particles 42a can and preferably do have at least a plurality of particle sizes different than at least a plurality of the particle sizes of the clumping particle size range of clumping particles 42b. In one embodiment, non-clumping particles 46a have varying particle sizes that make up at least one part of one of the aforementioned non-clumping particle size ranges and non-clumping particles 46b have varying particle sizes that make up at least another part of the one of the aforementioned non-clumping particle size ranges. Where the litter 40′ is composed of both clumping particles 42a and 42b, the clumping particle size range of clumping particles 42a can and preferably do have at least a plurality of particle sizes different than at least a plurality of the particle sizes of the clumping particle size range of clumping particles 42b. Where the litter 40′ is composed of both non-clumping particles 46a and 46b, the non-clumping particle size range of non-clumping particles 46a can have at least a plurality of particle sizes different than at least a plurality of the particle sizes of the non-clumping particle size range of non-clumping particles 46b.

In one such embodiment, (a) clumping particles 42a have varying particle sizes that make up at least one part of one of the aforementioned clumping particle size ranges and/or clumping particles 42b have varying particle sizes that make up at least another part of the one of the aforementioned clumping particle size ranges, and non-clumping particles 46a have varying particle sizes that make up at least one part of one of the aforementioned non-clumping particle size ranges and/or non-clumping particles 46b have varying particle sizes that make up at least another part of the one of the aforementioned non-clumping particle size ranges. The non-clumping particle size range of non-clumping particles 46a can have at least a plurality of particle sizes different than at least a plurality of the particle sizes of the non-clumping particle size range of non-clumping particles 46b

In one embodiment, the litter 40′ has (a) only clumping particles 42b in one of the aforementioned clumping particle weight percentages or clumping particle weight percentage ranges that are each at least partially composed of a starch-containing clumping material 44b, which preferably is a starch-based extrudate clumping material 44b containing at least 5%, preferably at least 10%, more preferably at least 15% of cold water soluble binder clumping agent, and (b) collectively in one of the aforementioned non-clumping weight percentages or weight percentage ranges at least one and preferably both (i) non-clumping particles 46a composed of one type of non-clumping material, such as preferably one of calcium bentonite, crushed nut shells or hulls, preferably crushed walnut shells, cellulosic fiber(s), wood fiber(s), paper fiber, e.g., paper balls or paper granules, perlite, sand, or another type of non-clumping material, and (ii) non-clumping particles 46b composed of a different type of non-clumping material, such as preferably one of calcium bentonite, crushed nut shells or hulls, preferably crushed walnut shells, cellulosic fiber(s), wood fiber(s), paper fiber, e.g., paper balls or paper granules, perlite, sand, or another type of non-clumping material. The clumping particles 42b have at least a plurality of pairs of different clumping particle sizes falling within one of the aforementioned clumping particle size ranges discussed above. If desired, the clumping particles 42b can be or include starch-based extrudate sorbent pellets 43 also referred to herein as extruded sorbent clumping pellets 43 which contain at least 5%, preferably at least 10%, more preferably at least 15% by pellet weight of cold-water soluble binder clumping agent. The non-clumping particles 46a and 46b each have at least a plurality of pairs of different clumping particle sizes falling (a) separately or individually within one of the aforementioned clumping particle size ranges discussed above, (b) collectively within one of the aforementioned clumping particle size ranges discussed above, or (c) within a corresponding one of the aforementioned clumping particle size ranges discussed above. The non-clumping particles 46a and 46b can have respective non-clumping particle size ranges which overlap or do not overlap but which collectively or separately fall within one of the aforementioned non-clumping particle size ranges discussed above.

In one such embodiment, the clumping particles 42b are at least partially and preferably substantially completely composed of starch-containing clumping material which preferably is a starch-based extrudate clumping material 44b and make up make up no greater than about 20%±5% of litter 40′. The clumping particles 42b preferably have a plurality of pairs of differently sized particles falling within a clumping particle size range of one of between 200 microns and 2000 microns, preferably 250 microns and 1900 microns, and more preferably between about 500 microns and about 1700 microns. The non-clumping particles 46a and/or 46b collectively make up at least 50%, preferably at least 60%, more preferably at least 70%, and even more preferably no more than about 80%+5% of the litter 40′ and have particle sizes ranging between 1400 microns and 5500 microns, preferably between 1500 microns and 5000 microns, and more preferably between 1700 microns and 4750 microns. In another embodiment, the clumping particles 42b are at least partially and preferably substantially completely composed of starch-containing clumping material which preferably is a starch-based extrudate clumping material 44b and make up make up no greater than about 30%±5% of litter 40′, the clumping particles 42b preferably have a plurality of pairs of differently sized particles falling within a clumping particle size range of one of between 200 microns and 2000 microns, preferably 250 microns and 1900 microns, and more preferably between about 500 microns and about 1700 microns, the non-clumping particles 46a and/or 46b collectively make up at least 50%, preferably at least 60%, more preferably at least 70%, and even more preferably at least about 80%±5% of the litter 40′, and have non-clumping particle sizes ranging between 1400 microns and 5500 microns, preferably between 1500 microns and 5000 microns, and more preferably between 1700 microns and 4750 microns The non-clumping particles 46a and/or 46b can be composed of the same clumping material, such as calcium bentonite, crushed nut shells or hulls, preferably crushed walnut shells, cellulosic fiber(s), wood fiber(s), paper fiber, e.g., paper balls or paper granules, perlite, sand, or another type of non-clumping material, or can be composed of different types of clumping materials 48a and 48b. Where composed of different types of clumping materials, non-clumping particles 46a can be composed of one or more of calcium bentonite, crushed nut shells or hulls, preferably crushed walnut shells, cellulosic fiber(s), wood fiber(s), paper fiber, e.g., paper balls or paper granules, perlite, sand, or another type of non-clumping material, and non-clumping particles 46b can be composed of a different one or more of calcium bentonite, crushed nut shells or hulls, preferably crushed walnut shells, cellulosic fiber(s), wood fiber(s), paper fiber, e.g., paper balls or paper granules, perlite, sand, or another type of non-clumping material. Where composed of the same type of non-clumping material, the non-clumping particles 46a and 46b preferably are each be composed of a plurality of pairs of differently sized particles that collectively fall within a non-clumping particle size range of between 1400 microns and 5500 microns, preferably between 1500 microns and 5000 microns, and more preferably between about 1700 microns and about 4750 microns. If desired, non-clumping particles 46a can have a plurality of pairs of differently sized particles falling within a first non-clumping particle size range that encompasses a first subset or first portion of one of the non-clumping particle size ranges of between 1400 microns and 5500 microns, between 1500 microns and 5000 microns, or between about 1700 microns and about 4750 microns and non-clumping particles 46b can have a plurality of pairs of differently sized particles falling within a second non-clumping particle size range that encompasses a second subset or second portion of the one of the non-clumping particle size ranges of between 1400 microns and 5500 microns, between 1500 microns and 5000 microns, or between about 1700 microns and about 4750 microns that is different than the first subset or first portion. The first non-clumping particle size range of non-clumping particles 46a can have particle sizes which overlap with particle sizes of the second non-clumping particle size range of non-clumping particles 46b, can be made up of a first non-clumping particle size range having differently sized particles 46a whose particle sizes extend to or adjacent but which do not overlap with the differently sized particles 46b of the second non-clumping particle size range, and can have a gap in particle sizes such that (i) the smallest sized non-clumping particles of one of the first or second particle size ranges of a corresponding one of the non-clumping particles 46a or 46b is the same as the smallest sized non-clumping particle of one of the aforementioned enumerated non-clumping particle size ranges, (ii) the largest sized non-clumping particles of the other one of the first or second particle size ranges of the corresponding other one of the non-clumping particles 46a or 46b is the same as the largest sized non-clumping particles of the one of the aforementioned enumerated non-clumping particle size ranges, and (iii) the largest sized non-clumping particles of the one of the first or second particle size ranges of a corresponding one of the non-clumping particles 46a or 46b is less than the smallest sized non-clumping particles of the other one of the first or second particle size ranges of the corresponding other one of the non-clumping particles 46a or 46b.

In another embodiment, the litter 40′ has a plurality of clumping particles 42a and 42b with one of the clumping particles 42a composed of one type of clumping material 44a, such as preferably sodium bentonite, gum-treated particles, gum-treated sand grains, gum-treated granules, gum-treated fibers, or gum-treated pellets, or another type of clumping material that is different than the clumping material 44b of clumping particles 42b, and the other one of the clumping particles 42b composed of a different type of clumping material 44b, such as preferably a starch-containing clumping material, such as preferably a starch-based extrudate clumping material 44b containing at least 5%, preferably at least 10%, more preferably at least 15% of cold water soluble binder clumping agent. Where clumping particles 42a are gum-treated, they can be treated such as by at least partially coating particles, grains of sand, granules, fibers or pellets with the gum. Where clumping particles 42a are gum-treated, they are preferably treated using guar gum such as by at least partially coating particles, grains of sand, granules, fibers or pellets with guar gum. The clumping particles 42a and 42b (a) collectively have or fall within one of the aforementioned clumping particle weight percentages or weight percent ranges, and (b) collectively or separately have or fall within one of the aforementioned clumping particle sizes or clumping particle size ranges discussed above. In such an embodiment, the litter 40′ has at least one of the non-clumping particles 46a or 46b composed of a corresponding non-clumping material 48a or 48b and present (1) in one of the aforementioned non-clumping particle weight percentages or weight percent ranges discussed above, and (2) having at least a plurality of pairs of different sized non-clumping particles falling within non-clumping particle size ranges discussed above. In one such embodiment, the litter 40′ is composed of non-clumping particles 46a and 46b that can be composed of different types of clumping materials 48a and 48b or which can be both composed of the same type of clumping material 48a or 48b but which have different non-clumping particle sizes or size ranges. Such an embodiment can include non-clumping particles 46a and 46b composed of a non-clumping material 48a and 48b different from one another and which (1) collectively are present in one of the aforementioned non-clumping particle weight percentages or weight percent ranges discussed above, and (2) each have at least a plurality of pairs of different sized non-clumping particles collectively or individually, e.g., separately, falling within one of the non-clumping particle size ranges discussed above. Non-clumping materials include calcium bentonite, crushed nut shells or hulls, preferably crushed walnut shells, cellulosic fiber(s), wood fiber(s), paper fiber, e.g., paper balls or paper granules, perlite, sand, or another type of non-clumping material.

While serving as an effective clumping litter 40 or 40′, the present litter formulations and embodiments disclosed herein have the additional benefit of being lightweight in comparison to prior art clumping litter. For instance, clumping particles 42b composed of starch-based clumping material 44b, that preferably is or includes starch-based extrudate composed of extrusion-modified starch cold water soluble binder clumping agent in an amount of at least 5%, preferably 10%, more preferably 15% by weight has approximately one-fifth of the bulk density of sodium bentonite 44a used for clumping particles 42a, and approximately one-third of the bulk density of the non-clumping materials 48, 48a and/or 48b, such as calcium bentonite and/or ground walnut shells, used for the non-clumping particles 46, 46a, and/or 46b in the aforementioned low tracking clumping litter product trial formulations. Thus, by increasing the proportion of clumping particles 42 or 42b made of starch-based clumping material 44 or 44b, preferably starch-based extrudate containing at least 5%, preferably at least 10%, more preferably at least 15% cold water soluble extrusion-modified starch binder clumping agent, used in the litter 40 or 40′, and non-clumping particles 46 or 46a of calcium bentonite 48 or 48a, which both have a lower bulk density than sodium bentonite, the weight of the litter 40 or 40′ decreases in comparison to traditional clumping cat litters having a larger proportion of litter particles of sodium bentonite.

Despite the lightweight nature of the low tracking litter Trial Formulation Nos. 1-6, each of these trial formulations results in quality clumps as reflected by the 10-minute and 30-minute drop test results for each one of the trial formulations listed in Table 3 of FIG. 7. As shown, two clumps were formed and weighed for each litter formulation trial number of the present invention. Thereafter, clump drop tests were conducted at intervals of ten minutes and thirty minutes, after which the clumps were again weighed (post-drop weight) and compared to the pre-drop weight. Clump retention percentages were then calculated by dividing the post-drop clump weight by the pre-drop clump weight and multiplying the result by 100. These clump retention results are comparable to those for existing commercially available clumping litter, which weigh considerably more than any of low tracking clumping litter Trial Formulation Nos. 1-6.

Furthermore, as shown in Table 4 of FIG. 8, each one of Trial Formulation Nos. 1-6 possess superior tracking characteristics as embodied by their respective litter particle tracking effectiveness numbers in Table 4 which were significantly lower, typically half or less than half, compared to several commercially available prior art clumping litters also listed in Table 4. This is because the sizes and types of clumping litter particles 42 or 42a and/or 42b and non-clumping particles 46, 46a and/or 46b and the materials 42, 44 or 44a, 44b, 48a and/or 44b used to make these trial blend formulations were selected to maximize the amount of voids around the larger non-clumping particles 46a and/or 46b that are or become filled by smaller clumping particles 42a and/or 42b when the litter 40 or 40′ is poured into a litter box 50. In particular the smaller particle sizes of the smaller clumping particles 42 or 42a and/or 42b relative to the larger sizes of the larger non-clumping particles 46 or 46a and/or 46b are selected to satisfy one or more of the aforementioned clumping/non-clumping particle size percentages, clumping/non-clumping particle size percentage ranges, clumping/non-clumping particle size ratios, clumping/non-clumping particle size range ratios and/or clumping/non-clumping particle size percentage range ratio ranges that has been discovered to produce low tracking clumping litters 40 or 40′ in accordance with the present invention having a desirably low litter particle tracking effectiveness of no greater than 150 litter particles per square inch, preferably no greater than 100 particles per square inch, more preferably no greater than 80 particles per square inch, and even more preferably no greater than about 60 particles per square inch and which form clump on or near the top surface 52 of the litter 40 or 40′. Such a low tracking clumping litter 40 or 40′ of the present invention preferably also produces low-shedding clumps having a clump retention rate of at least 95%, preferably at least 97% and more preferably at least 98% and/or has a desirably high clump compression strength of at least 50 pounds per square inch, preferably at least 100 pounds per square inch and more preferably 200 pounds per square inch. Such a low tracking clumping litter 40 or 40′ of the present invention preferably also is lightweight having a bulk density of no greater than 40 lbs/ft³, preferably no higher than about 38 lbs/ft³, and which preferably has a bulk density of at least 28 lbs/ft³, preferably at least 32 lbs/ft³.

Such low tracking clumping litter formulations where the voids 45 around the non-clumping particles 46 or 46a and/or 46b, such as where the non-clumping particles are composed of calcium bentonite, e.g., calcium bentonite granules, are filled by sufficiently small clumping particles 42 or 42a and/or 42b results in less movement of all of the litter particles 42, 44 of litter 40 or 42a, 42b, 46a and/or 46b of litter 40′. Stated differently, such low tracking clumping formulations do so by minimizing the amount of deflection of particles 42, 44 or 42a, 42b, 46a and/or 46b when a cat steps onto the surface 52 of litter 40 or 40′ in the litterbox 50, which in turn minimizes the amount of tracking of the particles 42, 44 of litter 40 or 42a, 42b, 46a and/or 46b of litter 40′ from the box 50.

The amount of moisture on a cat's paws can also influence the amount of tracking. A wet paw is more likely to track clumping particles 42 or 42a and/or 42b composed of clumping material 44, 44a and/or 44b out of the litterbox 50. Thus, by increasing the percentage by weight of the non-clumping materials 46 of litter 40 or 46a and/or 46b of litter 40′, for example, calcium bentonite 46a and/or walnut shells 46b of at least one blend formulation of litter 40′, the amount of tracking of litter particles 42a, 42b, 46a and/or 46b from the litter box 50 can further be reduced and preferably is minimized. Furthermore, static charges, which are common because cat fur oftentimes generates charges, can also impact the amount of tracking. Calcium bentonite 48a as well as walnut shells 48b advantageously do not carry charges, such that particles 46a and/or 46b these non-clumping materials 48a and/or 48b do not commonly attach to the cat's fur based on charges in the fur. Therefore, formulations which are composed of non-clumping particles 46 or 46a and/or 46b of a non-clumping material 48 or 48a and/or 48b which is an anti-static non-clumping material, one of which is an anti-static non-clumping material, and which can all be anti-static non-clumping materials, such as preferably calcium bentonite and/or walnut shells, advantageously produce a low tracking clumping litter 40 or 40′ of the present invention which has reduced tracking and which preferably further minimizes tracking as a result of the use of such anti-static non-clumping particles 46 or 46a and/or 46b.

Other types of antistatic materials which can be used include wood, e.g., sawdust, wood fibers or particles of wood, other types of plant hulls and shells, carbon, e.g., carbon black, carbon fiber, graphene, conductive polymer(s), metallic material(s), e.g., in comminuted or powdered form, silicone-based antistatic material, a conductive oxide or conductive oxide material, e.g., in comminuted or powdered form, another type of anti-static material or a combination of one or more of these antistatic materials. Such antistatic materials can take the form of a powder, coating, spray, treatment or other form used as, mixed with, and/or applied to non-clumping material 48 used in making non-clumping particles 46.

As a result of all the foregoing, as evidenced by the low litter tracking particle effectiveness data for the low tracking clumping litter product trial formulations listed in Table 4 of FIG. 8, all six low tracking litter product trial formulations made in accordance with the present invention have significantly lower litter tracking particle effectiveness numbers compared to the commercially available prior art litter blends also listed in Table 4 of FIG. 8. Such low tracking clumping litters 40 or 40′ formulated in accordance with the present invention preferably advantageously track less than half as many litter particles as the commercially available prior art litter blends listed in Table 4 of FIG. 8 track.

The present invention is directed to low tracking clumping litter that is a litter blend of: (a) clumping litter particles comprised of a clumping material and having at least a plurality of pairs of different clumping particle sizes, and (b) non-clumping litter particles comprised of a non-clumping material and having at least a plurality of pairs of different non-clumping particle sizes; and where the litter blend has a litter particle tracking effectiveness of no greater than 150 particles per square inch. The non-clumping particles have a plurality of pairs of different particle sizes that are larger than a plurality of pairs of different particle sizes of the clumping particles. The litter blend contains between about 10% and about 45%, preferably between 15% and 35%, and even more preferably about 30%, of the clumping litter particles by weight of the litter blend and between about 55% and about 90%, preferably between 65% and 85%, more preferably between 65% and 75%, even more preferably about 70%, of the non-clumping litter particles by weight of the litter blend. The proportion of the weight percent of the clumping particles of the litter blend relative to the weight percent of the non-clumping particles of the litter blend is between 0.10 and 0.82. A clump is formed by wetting with urine or water at least a plurality of pairs of the clumping particles that is composed of at least a plurality of pairs of the wetted clumping particles and at least a plurality of pairs of the non-clumping particles has a clump retention rate of at least 95%. The litter blend has a litter particle tracking effectiveness of no greater than 100 particles per square inch. The litter blend has a bulk density of between 20 lbs/ft³ and 50 lbs/ft³, preferably between 25 lbs/ft³ and 40 lbs/ft³, and more preferably between 27 lbs/ft³ and 37 lbs/ft³.

The clumping litter particles can be composed of a starch-based extrudate containing at least 5%, preferably at least 10%, and more preferably at least 15% by extrudate weight of a water-soluble binder clumping agent formed of starch modified into the water-soluble binder clumping agent during extrusion of the starch-based extrudate and a clump formed from wetting with urine or water at least a plurality of pairs of the clumping particles and which is composed of at least a plurality of pairs of the clumping particles and at least a plurality of pairs of the non-clumping particles has a clump retention rate of at least 97%. The starch-based extrudate is extruded from a starch-containing admixture, such as composed of one or more cereal grains and/or legumes, at an extrusion pressure of at least 2000 pounds per square inch, preferably 2500 pounds per square inch, and more preferably 3000 pounds per square inch using a single stage extruder from an extruder die having at least a plurality of pairs of die holes. The starch-based extrudate contains at least 5%, preferably at least 10%, more preferably at least 15%, by extrudate weight of a water-soluble binder clumping agent formed of starch modified into the water-soluble binder clumping agent during extrusion of the starch-based extrudate from the single screw extruder.

The clumping particles have a maximum particle size of no larger than 2000 microns and the non-clumping particles have a minimum particle size of no smaller than 1400 microns. The litter blend has a litter particle tracking effectiveness of no greater than 100 particles per square inch and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%. The clumping particles have a minimum particle size of no smaller than 200 microns and the non-clumping particles have a maximum particle size of no larger than 5500 microns. The clumping particles have a clumping particle size range of between 200 microns and 2000 microns, and the non-clumping particles have a non-clumping particle size range of between 1400 microns and 5500 microns.

The differently sized clumping particles have a mean clumping particle size, the differently sized non-clumping particles have a mean non-clumping particle size, and a mean particle size ratio of the mean non-clumping particle size divided by the mean clumping particle size ranges between 2.80 and 3.15, preferably between 2.85 and 3.05 and more preferably between about 2.88 and about 2.95. The clumping particles have a maximum particle size of no larger than 2000 microns, the non-clumping particles have a minimum particle size of no smaller than 1400 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%. The clumping particles have a minimum particle size of no smaller than 200 microns and the non-clumping particles have a maximum particle size of no larger than 5500 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%. The clumping particles have a clumping particle size range of between 200 microns and 2000 microns, and the non-clumping particles have a non-clumping particle size range of between 1400 microns and 5500 microns. The clumping litter particles can be composed of a starch-based extrudate containing at least 5% by extrudate weight of a water-soluble binder clumping agent formed of starch modified into the water-soluble binder clumping agent during extrusion of the starch-based extrudate and a clump formed from wetting with urine or water at least a plurality of pairs of the clumping particles and which is composed of at least a plurality of pairs of the clumping particles and at least a plurality of pairs of the non-clumping particles has a clump retention rate of at least 97%.

The clumping particles comprise a clumping particle weight percentage of the litter blend, the non-clumping particles comprise a non-clumping particle weight percentage, and a proportion of the weight percent of the clumping particles of the litter blend relative to the weight percent of the non-clumping particles of the litter blend ranges between 0.10 and 0.82. The litter blend contains between about 10% and about 45% of the clumping litter particles by weight of the litter blend and between about 55% and about 90% of the non-clumping litter particles by weight of the litter blend. The litter blend has a bulk density of between 20 lbs/ft³ and 50 lbs/ft³. The litter blend has a litter particle tracking effectiveness of no greater than 100 particles per square inch and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%. The clumping litter particles can be composed of a starch-based extrudate containing at least 5% by extrudate weight of a water-soluble binder clumping agent formed of starch modified into the water-soluble binder clumping agent during extrusion of the starch-based extrudate and a clump formed from wetting with urine or water at least a plurality of pairs of the clumping particles and which is composed of at least a plurality of pairs of the clumping particles and at least a plurality of pairs of the non-clumping particles has a clump retention rate of at least 97%.

The largest sized clumping particles are no larger than the smallest sized non-clumping particles, and a ratio of the smallest sized non-clumping particles relative to the largest sized clumping particles falls within a range of between about 1 and about 2.5. The clumping particles have a maximum particle size of no larger than 2000 microns, the non-clumping particles have a minimum particle size of no smaller than 1400 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%. The clumping particles have a minimum particle size of no smaller than 200 microns, the non-clumping particles have a maximum particle size of no larger than 5500 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%. The clumping particles have a clumping particle size range of between 200 microns and 2000 microns, and the non-clumping particles have a non-clumping particle size range of between 1400 microns and 5500 microns. The litter blend contains between about 10% and about 45% of the clumping litter particles by weight of the litter blend and between about 55% and about 90% of the non-clumping litter particles by weight of the litter blend and the litter blend has a bulk density of between 20 lbs/ft³ and 50 lbs/ft³. The clumping litter particles can be composed of a starch-based extrudate containing at least 5%, preferably at least 10%, and more preferably at least 15% by extrudate weight of a water-soluble binder clumping agent formed of starch modified into the water-soluble binder clumping agent during extrusion of the starch-based extrudate and a clump formed from wetting with urine or water at least a plurality of pairs of the clumping particles and which is composed of at least a plurality of pairs of the clumping particles and at least a plurality of pairs of the non-clumping particles has a clump retention rate of at least 97%.

In a preferred embodiment, the ratio of the smallest sized particles of the non-clumping particles to the smallest sized particles of the clumping particles is about 6.7±0.75 or between 5.95 and 7.45 and the ratio of the largest sized particles of the non-clumping particles to the largest sized particles of the clumping particles is about 2.8±0.75. In at least one preferred embodiment, the ratio of the smallest sized particles of the non-clumping particles to the smallest sized particles of the clumping particles ranges between about 6 and 7.5 and the ratio of the largest sized particles of the non-clumping particles to the largest sized particles of the clumping particles is ranges between 2 and 3.6. In a further preferred embodiment: (a) the ratio of the smallest sized particles of the non-clumping particles to the smallest sized particles of the clumping particles ranges between about 6.5 and about 17.5, and (b) the ratio of the largest sized particles of the non-clumping particles to the largest sized particles of the clumping particles ranges between about 2.2 and about 3.5, and the litter blend has a litter particle tracking effectiveness of no greater than 100 particles per square inch.

In yet another embodiment, the litter blend has a ratio of the lower non-clumping particle size range boundary to the lower clumping particle size boundary is no less than about 2:1 and a ratio of the upper non-clumping particle size range boundary to the upper clumping particle size range boundary is no greater than about 14:1. The ratio of the particle sizes of the non-clumping particles to the particle sizes of the clumping particles ranges between 2:1 and 14:1. In one or more such embodiments, the clumping particles have a size between about 250 microns and about 1680 microns and the non-clumping particles have a size between about 1680 microns and about 4760 microns. In yet another embodiment, the clumping particles can have a minimum particle size of between 250 microns and 500 microns.

### Litter Particle Tracking Effectiveness Test Procedure

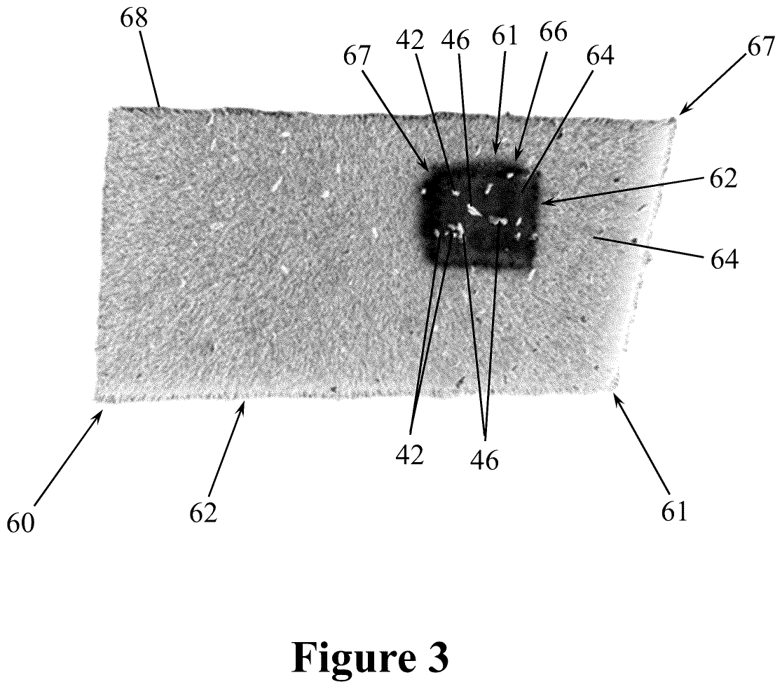

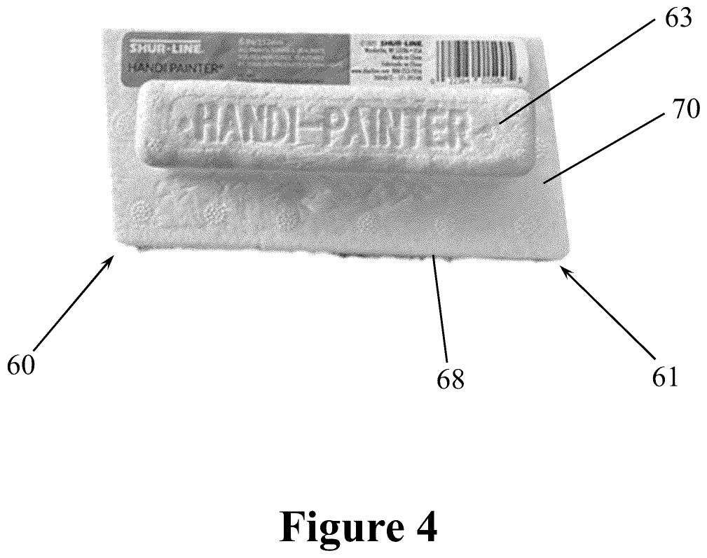

With reference to FIGS. 3 and 4, a preferred litter tracking effectiveness test tool 60 employs a generally flat or planar litter particle tracking pickup pad 61 with a fibrous face 62 facing in one direction and a handle 63 on the other side extending in the opposite direction. The pad 61 has a fibrous face 62 composed of relatively tightly packed uprightly extending fibers 64 that are litter particle pickup fibers 64 and which includes a generally, rectangular, e.g., square, litter particle tracking pickup pad region 66 shown in black in FIG. 3 that preferably is one inch by one inch square. In a preferred embodiment of the tool 60, the pad 61 preferably is a flocked fiber pad 67 with a fibrous face 62 of flocked fibers 64 that are litter particle pickup fibers. If desired, the tool 60 can be made to have the fibrous face 62 of the pad 61 to be limited to be one inch by one inch square.

With reference to FIG. 4, the pad 61 preferably is about a quarter inch thick in cross-section and includes a base 68 from which the fibers 64 outwardly extend with the base 68 supported by or on an underlying rigid backing 70 shown in FIG. 4 that can be made of a polystyrene foam, e.g., STYROFOAM, plastic, or the like from which the handle 63 outwardly extends. If desired, base 68 can include or be composed of a layer of foam, such as a layer of an open cell foam, which foam can be disposed between the fibers 64 and the backing 70. The pad 61 is about one quarter inch thick and the fibers 64 are made of a synthetic material, preferably nylon, having a fiber length of about 0.150 inches such that the fibers 64 stick out from the base 68, e.g., extend outwardly from the foam layer, about 0.150 inches. The flock density of the fibers 64 of the pad 61 can range from 200 grams per meter squared to 500 grams per meter squared. In a preferred embodiment, the tool 60 is a 1500C HANDI PAINTR made and sold by Shur-Line of Waukesha Wisconsin but a Shur-Line 1520C Trim and Touch Up Pad can also be used.

When pressed into granular litter, e.g., litter 40 or 40′ composed of particles 42 and 46 or particles 42a, 42b, 46a and/or 46b, such a pad 61 is configured for picking up particles of litter in a manner that simulates, and which preferably is predictive of a cat picking up litter particles of the litter from a litter box containing the litter and tracking litter particles out of the litter box. In carrying out a litter particle tracking effectiveness test in accordance with the present invention, the handle 63 of the tool 60 is manually grasped by a user, e.g., tester, and maneuvered so the fibrous face 62 of the pad 61 overlies the surface 52 of the litter 40 before being pressed straight down, and not at an angle, against and preferably at least slightly into the litter 40. Pressure is applied, such as preferably in an amount of 0.5 pounds per square inch of pressure, pressing the fibrous face 62 of the pad 61 against and/or into the surface 52 of the litter 40 for five seconds. Thereafter, the tool 60 is lifted straight up away from the litter's surface 52 out of the litter 40 disengaging the fibrous face 62 of the pad 61 from the litter 40. If desired, the pad 61 can be mounted on a test stand overlying the litter 40 to be tested that is designed or configured to be lowered directly vertically downwardly into the top surface 52 of the litter 40 to be tested applying a pressure of 0.5 pounds per square inch of the fibrous face 62 against the litter's surface 52 for five seconds before the pad 61 is vertically raised out of the litter 40 or 40′. This amount of pressure is intended to simulate the weight of a cat's paw pressing on the surface 52 of the litter 40 or 40′. The number of litter particles 42 and/or 46, which adhere to the fibers 64 of the one inch by one inch test region 66 of the fibrous face 62 of the pad 61 are counted, such as by removing the particles 42 and/or 46 which remain adhered to the pad 61 from the pad 61, to obtain a count of the number of litter particles per square inch that is the litter particle tracking effectiveness number. The count of the number of litter particles per square inch of the test region 66 of the pad 61 which became adhered thereto includes the number of clumping particles 42 and the number of non-clumping particles 46 which became adhered to the test region 66 of the pad 61 in carrying out a single litter particle tracking effectiveness test. Of course, the litter particle tracking effectiveness test can be performed on a multicomponent litter 40′ with the litter particle tracking effectiveness being the number of clumping particles 42a and 42b as well as the number of the non-clumping particles 46a and 46b which become adhered to the test region 66 of the pad 61 of the tool 60 during carrying out a single litter particle tracking effectiveness test. The number of litter particles per square inch of the test region 66 of the pad 61 which become adhered thereto during the test is representative of and preferably corresponds to the number of litter particles 42 and 46 or 42a and/or 42b and 46a and/or 46b tracked from the surface 52 of the litter 40 or 40′ in a litter box 50 by a cat using the litter 40 or 40′. The litter particles are removed after each test to ensure that there are no particles adhering to the test region 66 of the pad 61 before a new test is performed.

The litter particle tracking effectiveness test procedure can be and preferably is repeated at three other different locations of the outer surface 52 of the litter 40 or 40′. The total number of litter particles 42 and/or 46 or 42a, 42b, 46a and/or 46b picked up by the one-inch by one-inch square test pad region 66 are counted and divided by the number of test procedures performed to get an average litter particle tracking effectiveness number for the litter 40 or 40′ that enables the uniformity of the blend or formulation of the litter 40 or 40′ to be assessed. The litter particles 42 and 46 or 42a, 42b, 46a, and 46b are removed after each test to ensure that no particles remain adhering to the test region 66 of the pad 61 before a new test is performed. While this test procedure has been described herein being performed on a low tracking litter 40 or 40′ formulated and/or configured in accordance with the present invention, it can be used to obtain a litter particle tracking effectiveness of any clumping or non-clumping litter as demonstrated by the inclusion of litter particle tracking effectiveness data for commercially available clumping litters listed in Table 4 of FIG. 8.

### Clump Compression Strength Test Procedure

The following equipment was utilized in carrying out clump compression strength testing:
(1) 15 mL centrifuge tubes with screw top caps, plastic
(2) 3.0 mL disposable pipettes, plastic
(3) Distilled water
(4) Force Gauge: Mark-10 Model M7-500 S/N 3674412
(5) Motorized test stand: Model ESM303 S/N 3979431
(6) Digital control panel: Mark-10 Model DC4060 S/N 3680222
(7) DREMEL hand held high speed rotary power tool with deep cutting wheel
(8) Samples of extruded granular absorbent material (extruded pellets) to be wetted to form clumps therefrom to be compression strength tested.

Using the above, the following methodology was utilized in performing extruded granular absorbent (litter) clump compressive strength testing:
(1) Saw off tapered end of a 15 mL test tube, and clean off burrs.
(2) Screw on cap of test tube and fill tube with sample material to be tested.
(3) Add distilled water to sample material in test tube (1:1 by weight) to wet sample material
(4) Wait 10 seconds
(5) Unscrew cap from test tube and gently push “cast” clump formed of wetted sample material out of test tube using bulbous end of a plastic pipette (snug fit).
(6) Let cast clump sit and dry for 5 days at ambient room temperature conditions.
(7) Using deep cutting wheel attached to a DREMEL high speed rotary tool at high speed greater than 10,000 RPM, cut cast clump into barrel-shaped sections each approximately 0.5 inches thick or long.
(8) Measure the diameter and length of each barrel shaped cast clump section.
(9) Place barrel shaped (cylindrical) cast clump section on middle of compression test stand platform, with flat cut ends of barrel shaped cast clump section on top and bottom for compression testing by force gauge.
(10) Using a compression speed of 0.5 inches/minute, determine peak compression strength of barrel shaped cast clump section using force gauge.

### Clump Retention Rate Test Procedure

### (Clump Drop Test)

The clump retention rate is determined by adding 10 milliliters of water to (a) the litter 40 to wet the particles 42 and 46, or (b) the litter 40 to wet the clumping particles 42a and/or 42b and the non-clumping particles 46a and/or 46b and cause a clump to be formed in the litter 40 or 40′. After awaiting a predetermined period of time after the formation of the clump, which in one variation of the test is 10 minutes and another variation of the test is 30 minutes, the clump is weighed, referred to as the pre-drop weight, and then the clump is dropped from a height of 18 inches onto a No. 10 screen. The portion of the clump that remains after being dropped onto the screen is then weighed and is referred to as the post-drop weight. Any portion shed from the clump from the impact with the screen will result in the post-drop weight being less than the pre-drop weight. The clump retention rate is the decimal result of the post-drop clump weight divided by the pre-drop clump weight multiplied by 100 to express the clump retention rate as a percentage of the original clump that is left after being dropped.

In a preferred implementation of the 10-minute test, the clump is removed from the litter 40 or 40′ ten minutes after formation of the clump, weighed to obtain the pre-drop clump weight, dropped from a height of 18 inches onto the screen, and the portion of the clump remaining on the screen after being dropped onto the screen is weighed to obtain the post-drop clump weight. In a preferred implementation of the 30-minute test, the clump is removed from the litter 40 or 40′ thirty minutes after formation of the clump, weighed to obtain its pre-drop weight, dropped from a height of 18 inches onto the screen, and the clump remaining on the screen after being dropped is weighed to obtain its post-drop weight. For each clump, the post-drop clump weight is divided by the pre-drop clump weight and the result is multiplied by 100 to obtain the clump retention rate of the clump.

It is also to be understood that, although the foregoing description and drawings describe and illustrate in detail one or more preferred embodiments of the present invention, to those skilled in the art to which the present invention relates, the present disclosure will also suggest various modifications, constructions, and alternatives, as well as different embodiments and applications all of which are contemplated as being within the scope of the invention. The present invention, therefore, is intended to be limited only by the scope of the appended claims.

It is claimed:

1. A low tracking clumping litter comprised of a litter blend of:
(a) clumping litter particles comprised of a clumping material and having at least a plurality of pairs of different clumping particle sizes, and
(b) non-clumping litter particles comprised of a non-clumping material and having at least a plurality of pairs of different non-clumping particle sizes; and
wherein the litter blend has a litter particle tracking effectiveness of no greater than 150 particles per square inch.

2. The low tracking clumping litter of claim 1, wherein the non-clumping particles have a plurality of pairs of different particle sizes that are larger than a plurality of pairs of different particle sizes of the clumping particles.

3. The low tracking clumping litter of claim 2, wherein the litter blend contains between about 10% and about 45% of the clumping litter particles by weight of the litter blend and between about 55% and about 90% of the non-clumping litter particles by weight of the litter blend.

4. The low tracking clumping litter of claim 3, wherein the proportion of the weight percent of the clumping particles of the litter blend relative to the weight percent of the non-clumping particles of the litter blend is between 0.10 and 0.82.

5. The low tracking clumping litter of claim 4, wherein a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

6. The low tracking clumping litter of claim 4, wherein the litter blend has a litter particle tracking effectiveness of no greater than 100 particles per square inch.

7. The low tracking clumping litter of claim 4, wherein the litter blend has a bulk density of between 20 lbs/ft³ and 50 lbs/ft³.

8. The low tracking clumping litter of claim 4, wherein the clumping particles have a maximum particle size of no larger than 2000 microns and the non-clumping particles have a minimum particle size of no smaller than 1400 microns.

9. The low tracking clumping litter of claim 8, wherein the litter blend has a litter particle tracking effectiveness of no greater than 100 particles per square inch and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

10. The low tracking clumping litter of claim 4, wherein the clumping particles have a minimum particle size of no smaller than 200 microns and the non-clumping particles have a maximum particle size of no larger than 5500 microns.

11. The low tracking clumping litter of claim 10, wherein the litter blend has a litter particle tracking effectiveness of no greater than 100 particles per square inch and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

12. The low tracking clumping litter of claim 4, wherein the clumping particles have a clumping particle size range of between 200 microns and 2000 microns, and the non-clumping particles have a non-clumping particle size range of between 1400 microns and 5500 microns.

13. The low tracking clumping litter of claim 12, wherein the litter blend has a litter particle tracking effectiveness of no greater than 100 particles per square inch and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

14. The low tracking clumping litter of claim 3, wherein the differently sized clumping particles have a mean clumping particle size, the differently sized non-clumping particles have a mean non-clumping particle size, and a mean particle size ratio of the mean non-clumping particle size divided by the mean clumping particle size ranges between 2.80 and 3.15.

15. The low tracking clumping litter of claim 14, wherein the clumping particles have a maximum particle size of no larger than 2000 microns, the non-clumping particles have a minimum particle size of no smaller than 1400 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

16. The low tracking clumping litter of claim 14, wherein the clumping particles have a minimum particle size of no smaller than 200 microns and the non-clumping particles have a maximum particle size of no larger than 5500 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

17. The low tracking clumping litter of claim 14, wherein the clumping particles have a clumping particle size range of between 200 microns and 2000 microns, and the non-clumping particles have a non-clumping particle size range of between 1400 microns and 5500 microns.

18. The low tracking clumping litter of claim 1, wherein the clumping particles have a maximum particle size of no larger than 2000 microns, the non-clumping particles have a minimum particle size of no smaller than 1400 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

19. The low tracking clumping litter of claim 1, wherein the clumping particles have a minimum particle size of no smaller than 200 microns and the non-clumping particles have a maximum particle size of no larger than 5500 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

20. The low tracking clumping litter of claim 1, wherein the clumping particles have a clumping particle size range of between 200 microns and 2000 microns, and the non-clumping particles have a non-clumping particle size range of between 1400 microns and 5500 microns.

21. The low tracking clumping litter of claim 20, wherein a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

22. The low tracking clumping litter of claim 20, wherein the clumping particles comprise a clumping particle weight percentage of the litter blend, the non-clumping particles comprise a non-clumping particle weight percentage, and a proportion of the weight percent of the clumping particles of the litter blend relative to the weight percent of the non-clumping particles of the litter blend ranges between 0.10 and 0.82.

23. The low tracking clumping litter of claim 22, wherein the litter blend contains between about 10% and about 45% of the clumping litter particles by weight of the litter blend and between about 55% and about 90% of the non-clumping litter particles by weight of the litter blend.

24. The low tracking clumping litter of claim 23, wherein the litter blend has a bulk density of between 20 lbs/ft³ and 50 lbs/ft³.

25. The low tracking clumping litter of claim 24, wherein the litter blend has a litter particle tracking effectiveness of no greater than 100 particles per square inch and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

26. The low tracking clumping litter of claim 1, wherein the largest sized clumping particles are no larger than the smallest sized non-clumping particles, and a ratio of the smallest sized non-clumping particles relative to the largest sized clumping particles falls within a range of between about 1 and about 2.5.

27. The low tracking clumping litter of claim 26, wherein the clumping particles have a maximum particle size of no larger than 2000 microns, the non-clumping particles have a minimum particle size of no smaller than 1400 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

28. The low tracking clumping litter of claim 26, wherein the clumping particles have a minimum particle size of no smaller than 200 microns, the non-clumping particles have a maximum particle size of no larger than 5500 microns, and a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

29. The low tracking clumping litter of claim 26, wherein the clumping particles have a clumping particle size range of between 200 microns and 2000 microns, and the non-clumping particles have a non-clumping particle size range of between 1400 microns and 5500 microns.

30. The low tracking clumping litter of claim 29, wherein the litter blend has a litter particle tracking effectiveness of no greater than 100 particles per square inch.

31. The low tracking clumping litter of claim 30, wherein a clump formed by wetting with urine or water at least a plurality of pairs of the clumping particles that is composed of at least a plurality of pairs of the wetted clumping particles and at least a plurality of pairs of the non-clumping particles has a clump retention rate of at least 95%.

32. The low tracking clumping litter of claim 29, wherein the litter blend contains between about 10% and about 45% of the clumping litter particles by weight of the litter blend and between about 55% and about 90% of the non-clumping litter particles by weight of the litter blend.

33. The low tracking clumping litter of claim 32, wherein the litter blend has a bulk density of between 20 lbs/ft³ and 50 lbs/ft³.

34. The low tracking clumping litter of claim 1, wherein the clumping litter particles are comprised of a starch-based extrudate containing at least 5% by extrudate weight of a water-soluble binder clumping agent formed of starch modified into the water-soluble binder clumping agent during extrusion of the starch-based extrudate, and a clump formed from wetting with urine or water at least a plurality of pairs of the clumping particles and which is composed of at least a plurality of pairs of the clumping particles and at least a plurality of pairs of the non-clumping particles has a clump retention rate of at least 97%.

35. The low tracking clumping litter of claim 1, wherein one set of a plurality of pairs of the clumping particles are comprised of a starch-based clumping material and another set of a plurality of pairs of the clumping particles are comprised of sodium bentonite.

36. The low tracking clumping litter of claim 35, wherein the non-clumping particles are comprised of one of a calcium bentonite and comminuted walnut shells.

37. The low tracking clumping litter of claim 2, wherein the ratio of the smallest sized particles of the non-clumping particles to the smallest sized particles of the clumping particles is about 6.7±0.75 or between 5.95 and 7.45.

38. The low tracking clumping litter of claim 2, wherein the ratio of the largest sized particles of the non-clumping particles to the largest sized particles of the clumping particles is about 2.8±0.75.

39. The low tracking clumping litter of claim 2, wherein the ratio of the smallest sized particles of the non-clumping particles to the smallest sized particles of the clumping particles ranges between about 6 and 7.5 and the ratio of the largest sized particles of the non-clumping particles to the largest sized particles of the clumping particles is ranges between 2 and 3.6.

40. The low tracking clumping litter of claim 1, wherein (a) the ratio of the smallest sized particles of the non-clumping particles to the smallest sized particles of the clumping particles ranges between about 6.5 and about 17.5, and (b) the ratio of the largest sized particles of the non-clumping particles to the largest sized particles of the clumping particles ranges between about 2.2 and about 3.5, and wherein the litter particle tracking effectiveness of the litter blend is no greater than 100 particles per square inch.
